(19) United States
(12) Patent Application Publication
(10) Pub. No.: US 2013/0107736 A1
(43) Pub. Date: May 2, 2013

(54) PORTABLE NETWORK COMMUNICATION DEVICE, METHOD OF SELECTING ACTIVE NETWORK INTERFACE AND COMPUTER READABLE STORAGE MEDIUM

(71) Applicant: BUFFALO INC., Nagoya-shi (JP)

(72) Inventor: Daisuke YAMADA, Nagoya-shi (JP)

(73) Assignee: BUFFALO INC., Nagoya-shi (JP)

(21) Appl. No.: 13/655,495

(22) Filed: Oct. 19, 2012

(30) Foreign Application Priority Data
Nov. 2, 2011 (JP) 2011-240857

(51) Int. Cl. H04W 92/10; H04W 24/02

(52) U.S. Cl. 370/252

(57) ABSTRACT

A portable network communication device includes a plurality of first network interfaces, a communication controller that sends and receives a packet via one of the plurality of first network interfaces, a received signal strength determiner that determines a received signal strength of a signal received from each of the wireless base stations via each of the plurality of first network interfaces, a signal strength change calculator that calculates a value of change representing a magnitude of a change in determined received signal strength per unit time with respect to each of the plurality of first network interfaces, and an interface selector that selects a active network interface that is the first network interface used to send and receive the packet, among the plurality of first network interfaces, based on the calculated value of change.

### CROSS-REFERENCE TO RELATED APPLICATIONS

This application claims priority under 35 U.S.C. §119 to Japanese Patent Application No. 2011-240857 filed on Nov. 2, 2011, which is hereby incorporated by reference in its entirety and for all purposes.

### BACKGROUND

1. Technical Field

The disclosure relates to packet sending and receiving technology in a communication network.

2. Related Art

Portable wireless relay devices have been proposed to enable Internet access by a communication terminal, such as a personal computer. For example, a portable wireless relay device disclosed in JP 2010-21878A includes a network interface configured to connect with a communication terminal and a plurality of wireless network interfaces configured to connect to the Internet. This wireless relay device selects a working wireless network interface according to a specified condition among the plurality of wireless network interfaces.

The portable wireless relay device may be carried by the user to a different location, so that there may be changes in number and type of obstacles located between the portable wireless relay device and a wireless base station in a wireless network and a change in distance therebetween. This may result in unstable communication with a change in strength of the radio signal between the portable wireless relay device and the wireless base station. The portable wireless relay device disclosed in JP 2010-21878, however, has difficulty in eliminating such unstableness of communication, since the working network interface (active network interface) is selected based on the power consumptions of the respective wireless network interfaces and an upper layer protocol.

This problem is not characteristic of the portable wireless relay devices but is commonly found in any portable network communication devices including cell phone devices. For example, with a change in service location of the cell phone device, there may be changes in number and type of obstacles located between the cell phone device and a wireless base station and a change in distance therebetween, which may result in unstable communication.

There is accordingly a need, as recognized by the present inventor, to improve the stability of communication using a portable network communication device.

### SUMMARY

According to one exemplary embodiment, the disclosure is directed to a portable network communication device. The portable network communication device includes a plurality of first network interfaces that establish wireless communication with wireless base stations respectively belonging to different wireless networks; a communication controller that sends and receives a packet via one of the plurality of first network interfaces; a received signal strength determiner that determines a received signal strength of a signal received from each of the wireless base stations via each of the plurality of first network interfaces; a signal strength change calculator that calculates a value of change representing a magnitude of a change in determined received signal strength per unit time with respect to each of the plurality of first network interfaces; and an interface selector that selects a active network interface that is a first network interface used to send and receive the packet, among the plurality of first network interfaces, based on the value of change calculated by the signal strength calculator.

According to another embodiment, the disclosure is directed to a method of selecting a active network interface that is a first network interface used to send and receive a packet among a plurality of first network interfaces in a portable network communication device having the plurality of first network interfaces that establish wireless communication with wireless base stations respectively belonging to different networks. The method includes determining a received signal strength of a signal received from each of the wireless base stations with respect to each of the plurality of first network interfaces, calculating a value of change representing a magnitude of a change in determined received signal strength per unit time with respect to each of the plurality of first network interfaces, and selecting the active network interface, based on the calculated value of change that was previously calculated.

According to another embodiment, the disclosure is directed to a non-transitory computer readable storage medium having computer readable instructions stored therein that when executed by a portable communication device having a plurality of first network interfaces that establish wireless communication with wireless base stations respectively belonging to different wireless networks, cause the portable network communication device to perform a method of selecting a active network interface that is a first network interface used to send and receive a packet among the plurality of first network interfaces. The method comprises determining a received signal strength of a signal received from each of the wireless base stations with respect to each of the plurality of first network interfaces, calculating a value of change representing a magnitude of a change in determined received signal strength per unit time with respect to each of the plurality of first network interfaces, and selecting the active network interface, based on the value of change that was previously calculated.

### BRIEF DESCRIPTION OF DRAWINGS

FIG. 1 is a block diagram illustrating a configuration of a portable network relay device as one embodiment of the portable network communication device of the disclosure;

FIG. 2 schematically illustrates a communication mode using the portable network relay device;

FIG. 3 is a flowchart showing a procedure of relay network interface selecting process according to the first embodiment;

FIG. 4 schematically illustrates a first example of selecting the relay network interface;

FIG. 5 schematically illustrates a second example of selecting the relay network interface;

FIG. 6 is a block diagram illustrating the configuration of a portable network relay device according to a second embodiment;

FIG. 7 is a flowchart showing a procedure of relay network interface selecting process according to the second embodiment;

FIG. 8 is a flowchart showing a procedure of relay network interface selecting process according to a third embodiment;

FIG. 9 is a block diagram illustrating the configuration of a portable network relay device according to a fourth embodiment;

FIG. 10 is a flowchart showing a procedure of relay network interface selecting process according to the fourth embodiment;

FIG. 11 is a block diagram illustrating the configuration of a portable network relay device according to a fifth embodiment;

FIG. 12 is a flowchart showing a procedure of relay network interface selecting process according to the fifth embodiment;

FIG. 13 is a block diagram illustrating the configuration of a portable network relay device according to a sixth embodiment;

FIG. 14 illustrates one example of the settings of the wireless base station table shown in FIG. 13;

FIG. 15 illustrates one example of the settings of the received signal strength indication table shown in FIG. 13;

FIG. 16 is a flowchart showing a procedure of received signal strength indication determining process according to the sixth embodiment;

FIG. 17 is a block diagram illustrating the configuration of a cell phone device as one embodiment of the portable network communication device of the disclosure;

FIG. 18 schematically illustrates a communication mode using the cell phone device according to the seventh embodiment; and

FIG. 19 is a flowchart showing a procedure of working network interface selecting process according to the seventh embodiment.

### DESCRIPTION OF EMBODIMENTS

### A. First Embodiment

A1. Device Configuration

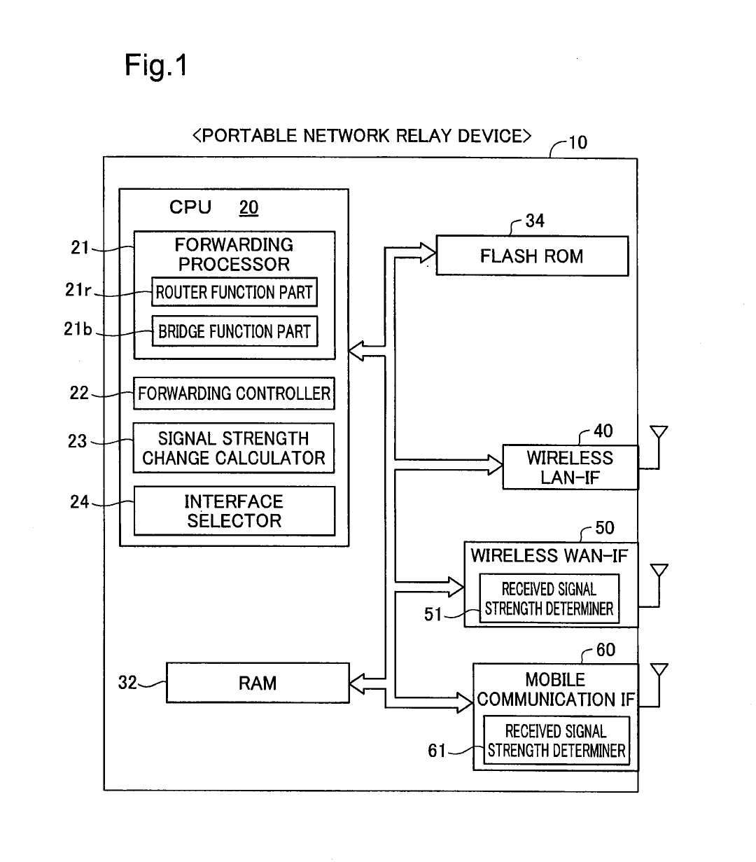

FIG. 1 is a block diagram illustrating the configuration of a portable network relay device 10 as one embodiment of the portable network communication device of the disclosure. The portable network relay device 10 includes a wireless LAN (Local Area Network) interface (hereinafter referred to as “wireless LAN-IF”) 40, a wireless WAN (Wide Area Network) interface (hereinafter referred to as “wireless WAN-IF”) 50, a mobile communication interface (hereinafter referred to as “mobile communication IF”) 60, a CPU (Central Processing Unit) 20, a flash ROM (Read-Only Memory) 34 and a RAM (Random Access Memory) 32. The portable network relay device 10 serves to connect a wireless LAN client, such as a personal computer or a game machine, to the Internet or to a different wireless LAN from a wireless LAN that the wireless LAN client belongs to.

The wireless LAN-IF 40 includes a modulator, an amplifier and an antenna. The wireless LAN-IF 40 works as a wireless LAN access point conforming to, for example, IEEE802.11b/g/n to establish wireless communication with a wireless LAN client (e.g., personal computer or game machine).

The wireless WAN-IF 50 includes a modulator, an amplifier and an antenna. The wireless WAN-IF 50 works as a wireless LAN client conforming to, for example, IEEE802.11a/b/g/n to establish wireless communication with a wireless base station, i.e., an access point, of a wireless LAN (e.g., access point of a public wireless LAN). The wireless WAN-IF 50 has a received signal strength determiner 51. The received signal strength determiner 51 determines the received signal strength indication (RSSI) of a signal output from the wireless LAN access point.

The mobile communication IF 60 includes a modulator, an amplifier and an antenna. The mobile communication IF 60 works as a mobile communication terminal conforming to, for example, 3G/HSPA to establish wireless communication with a wireless base station of a mobile communication network. The mobile communication IF 60 has a received signal strength determiner 61. The received signal strength determiner 61 determines the received signal strength indication of a signal output from the wireless base station of the mobile communication network.

As described above, the portable network relay device 10 of the first embodiment has the wireless WAN-IF 50 and the mobile communication IF 60 as a plurality of network interfaces to establish wireless communication with wireless base stations respectively belonging to different wireless networks.

A group of programs are stored in advance in the flash ROM 34. The CPU 20 executes the group of programs to serve as a forwarding processor 21, a forwarding controller 22, a signal strength change calculator 23 and an interface selector 24.

The forwarding processor 21 has a router function part 21r and a bridge function part 21b. The forwarding processor 21 forwards packets (layer 3 packets and layer 2 frames) input via the respective wireless communication interfaces (wireless LAN-IF 40, wireless WAN-IF 50 and mobile communication IF 60), based on respective destination addresses. The router function part 21r serves to relay layer 3 packets. The bridge function part 21b serves to relay layer 2 frames. The portable network relay device 10 works as a router device when both the router function part 21r and the bridge function part 21b are enabled, while working as a bridge device when only the bridge function part 21b is enabled.

The forwarding controller 22 controls the forwarding processor 21. More specifically, the forwarding controller 22 can create and update various tables for routing selection (e.g., routing table and ARP table) used by the forwarding processor 21 to relay packets.

The signal strength change calculator 23 calculates variations in received signal strength per unit time in the wireless WAN-IF 50 and in the mobile communication IF 60. Hereinafter the variation in received signal strength per unit time is referred to as “variation per unit time”. The interface selector 24 selects either one of the wireless WAN-IF 50 and the mobile communication IF 60 as the network interface of the relay destination of a packet received from the wireless LAN-IF 40. Hereinafter the network interface of the relay destination of a packet received from the wireless LAN-IF 40 is referred to as “relay network interface” or “relay network IF”.

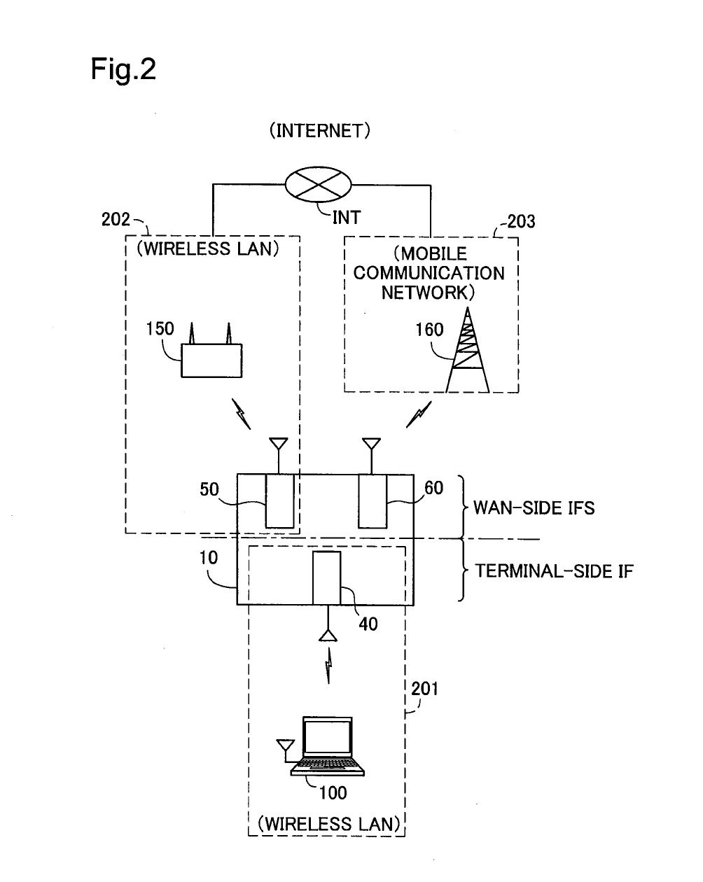

FIG. 2 schematically illustrates a communication mode using the portable network relay device. In the communication mode of FIG. 2, the personal computer 100 working as a communication terminal and the portable network relay device 10 are connected with an identical wireless LAN 201. In the wireless LAN 201, the portable network relay device 10 works as a wireless LAN access point, while the personal computer 100 works as a wireless LAN client. In this mode, the wireless LAN-IF 40 serves as the network interface to establish wireless communication with a wireless terminal (terminal-side IF).

In the communication mode of FIG. 2, the portable network relay device 10 and a wireless LAN access point device 150 are connected with an identical wireless LAN 202. In the wireless LAN 202, the portable network relay device 10 works as a wireless LAN client, while the wireless LAN access point device 150 works as a wireless LAN access point. The portable network relay device 10 uses its wireless WAN-IF 50 to establish wireless communication with the wireless LAN access point device 150. The wireless LAN 202 is connected to the Internet INT via an ISP (Internet Service Provider) network.

In the communication mode of FIG. 2, the portable network relay device 10 uses the mobile communication IF 60 to establish wireless communication with a wireless base station 160 in a mobile communication network 203. The mobile communication network 203 is connected to the Internet INT. The portable network relay device 10 accordingly has the wireless WAN-IF 50 and the mobile communication IF 60 as the network interface used to connect with a network on the Internet INT-side (in other words, different network from the network that the personal computer 100 belongs to) (hereinafter referred to as WAN-side IF).

In the communication mode of FIG. 2, the personal computer 100 establishes communication with a device (e.g., Web server) that is connected to the Internet INT, via the wireless LAN 201 and the wireless LAN 202. In this case, the wireless WAN-IF 50 serves as the relay network IF. The personal computer 100 also establishes communication with a device that is connected to the Internet INT, via the wireless LAN 201 and the mobile communication network 203. In this case, the mobile communication IF 60 serves as the relay network IF.

The portable network relay device 10 performs a relay network interface selecting process (described below) to select one of the two network interfaces that are the WAN-side IFs (wireless WAN-IF 50 and mobile communication IF 60) to serve as the relay network IF. The portable network relay device 10 performs this process to improve the stability of communication via the portable network relay device 10.

This portable network relay device 10 is sometimes referred to as the portable network communication device. The relay network interface is sometimes described as the active network interface; the wireless WAN-IF and the mobile communication IF 60 are sometimes described herein as the plurality of first network interfaces; the wireless LAN-IF 40 is sometimes described herein as the second network interface; the forwarding processor 21 and the forwarding controller 22 are sometimes described herein as the communication controller; the signal strength change calculator 23 is sometimes described herein as the received signal strength calculator; and the variation per unit time is sometimes described herein as the value of change.

A2. Relay Network Interface Selecting Process

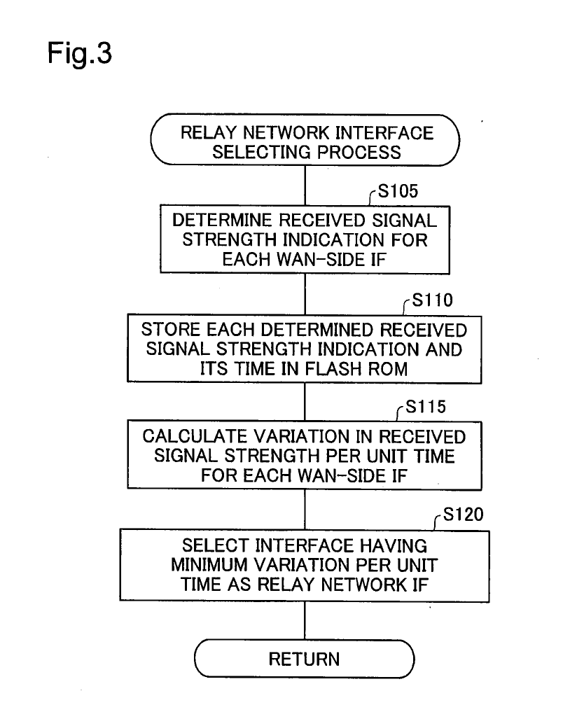

FIG. 3 is a flowchart showing a procedure of relay network interface selecting process according to the first embodiment. When the portable network relay device 10 is powered on, the relay network interface selecting process is performed repeatedly.

The received signal strength determiner 51 of the wireless WAN-IF 50 determines the received signal strength indication for the wireless WAN-IF 50, while the received signal strength determiner 61 of the mobile communication IF 60 determines the received signal strength indication for the mobile communication IF 60 (step S105). More specifically, for example, the received signal strength determiner 51 may detect the received signal strength of a beacon output from the wireless LAN access point device 150 to determine the received signal strength indication. The received signal strength determiner 61 may receive a signal including a received signal strength indication from the mobile communication network via the wireless base station 160 to determine the received signal strength indication. When receiving signals output from a plurality of wireless base stations, the received signal strength determiner 51 or the received signal strength determiner 61 determines the maximum received signal strength indication as the received signal strength indication for each corresponding WAN-side IF.

The signal strength change calculator 23 stores each of the received signal strength indications determined at step S105 and its time when the received signal strength indication is determined, in the flash ROM 34 (step S110). The signal strength change calculator 23 subsequently calculates a variation per unit time of each of the received signal strength indications stored in the flash ROM 34 with respect to each of the WAN-side IFs (step S115). More specifically, the signal strength change calculator 23 may read out a previous received signal strength indication determined in the previous cycle and its time and a current received signal strength indication determined in the current cycle and its time from the flash ROM 34, calculate the absolute value of the difference between these two received signal strength indications, and divide the calculated absolute value by a time interval between the time when the previous received signal strength indication is determined and the time when the current received signal strength indication is determined, so as to calculate the variation per unit time.

The interface selector 24 then selects a network interface having the minimum variation per unit time out of the WAN-side IFs as the relay network IF, based on the variations per unit time calculated at step S115 (step S120). The user may use the portable network relay device 10 while moving, because of its high portability. In this case, accompanied with changes in number and type of obstacles located between the portable network relay device 10 and a wireless base station (e.g., wireless LAN access point device 150 in the wireless LAN 202 or the wireless base station 160 in the mobile communication network 203) or a change in distance between the portable network relay device 10 and the wireless base station, there may be a change in radio wave environment, which may lead to unstable communication via the portable network relay device 10. The portable network relay device 10 accordingly selects the network interface having the minimum variation per unit time between the WAN-IF 50 and the mobile communication IF 60 that are the WAN-side IFs, as the relay network IF. Selecting the relay network IF in this way enables communication via the network of the relatively stable radio wave environment, thus improving the stability of communication via the portable network relay device 10.

The wireless WAN-IF 50 and the mobile communication IF 60 have different communication systems and different methods of determining the received signal strength indication and may thus employ different standards for determination of the received signal strength indication (i.e., unit of received signal strength indication to be determined). It is thus preferable to adjust one of the variations per unit time calculated at step S115 for the wireless WAN-IF 50 and the mobile communication IF 60 relative to the other as a standard. Alternatively it is preferable to adjust (normalize) both the calculated variations per unit time relative to another identical standard. Such adjustment enables, for example, conversion of the variation per unit time with a comparator, conversion of the variation per unit time by referring to a table provided in advance to have the settings of converted values or calculation of a converted value according to a specified operation equation.

After selecting the relay network IF, the forwarding controller 22 registers the selected relay network IF in a routing table. As a result, the network interface (i.e., wireless WAN-IF 50 or mobile communication IF 60) selected as the relay network IF is used for communication between the personal computer 100 and a device connected to the Internet INT.

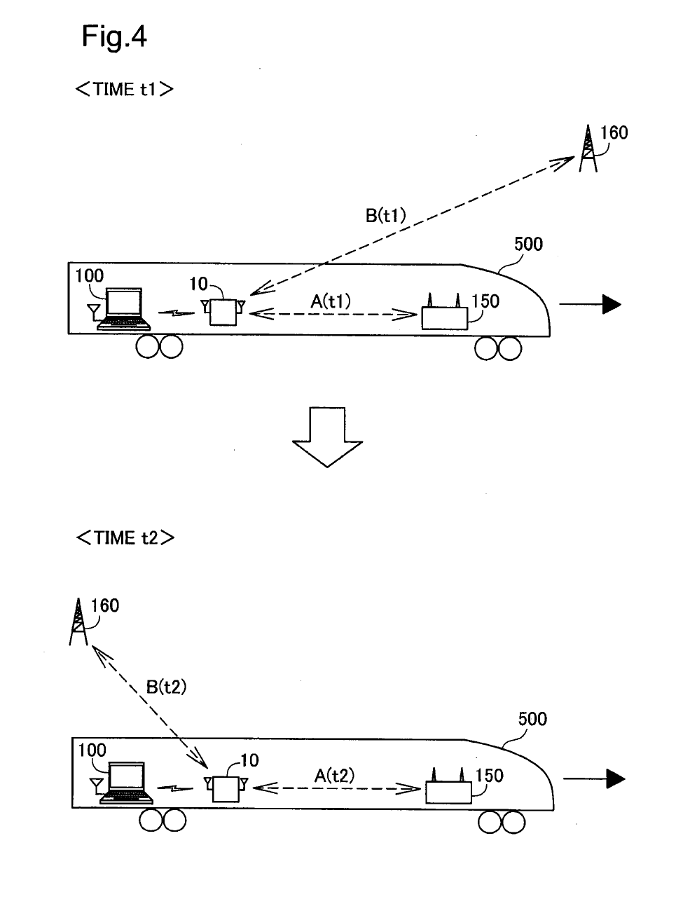

FIG. 4 schematically illustrates a first example of selecting the relay network interface. In the illustrated example of FIG. 4, the wireless LAN access point device 150 is fixedly mounted on a train vehicle 500. The user riding on the train vehicle 500 carries the portable network relay device 10 and the personal computer 100 and powers on the portable network relay device 10 and the personal computer 100 in the train vehicle 500. The train vehicle 500 is running. The wireless base station 160 is located outside the train vehicle 500.

As shown in the upper drawing of FIG. 4, at a time t1, the received signal strength indication determined for the wireless WAN-IF 50 is A(t1), and the received signal strength indication determined for the mobile communication IF 60 is B(t1). As shown in the lower drawing of FIG. 4, at a time t2 when the processing of step S105 is performed, the received signal strength indication determined for the wireless WAN-IF 50 is A(t2), and the received signal strength indication determined for the mobile communication IF 60 is B(t2).

The wireless LAN access point device 150 and the portable network relay device 10 are both located in the train vehicle 500, so that there are no substantial changes in number and type of obstacles located between the devices and no substantial change in distance between the devices at the time t1 and at the time t2. This results in the extremely small absolute value of the difference between the received signal strength indication A(t1) and the received signal strength indication A(t2).

The wireless base station 160 is, on the other hand, located outside the train vehicle 500, so that there are significant changes in number and type of obstacles located between the wireless base station 160 and the portable network relay device 10 and a significant change in distance between the devices, as the train vehicle 500 moves. This results in the relatively large absolute value of the difference between the received signal strength indication B(t1) and the received signal strength indication B(t2). The variation per unit time calculated for the wireless WAN-IF 50 is accordingly smaller than the variation per unit time calculated for the mobile communication IF 60, so that the wireless WAN-IF 50 is selected as the relay network IF.

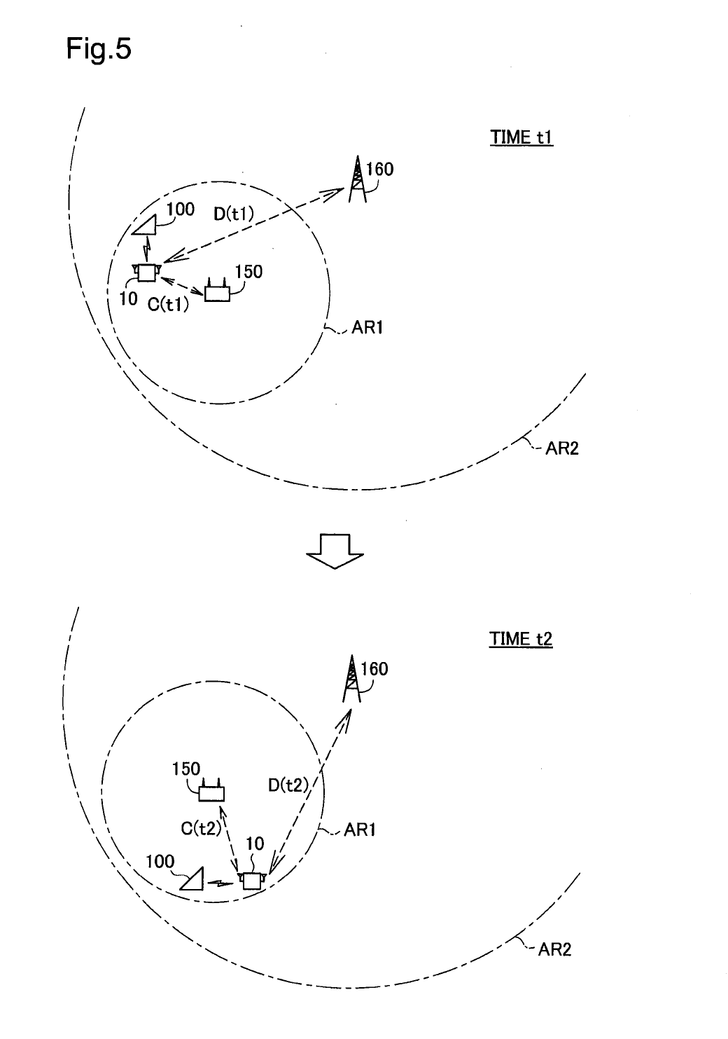

FIG. 5 schematically illustrates a second example of selecting the relay network interface. In the illustrated example of FIG. 5, both the wireless LAN access point device 150 and the wireless base station 160 are fixedly mounted. The user carries the portable network relay device 10 and the personal computer 100 and moves, for example, in the car.

As shown in FIG. 5, a coverage AR1 of signals output from the wireless LAN access point device 150 is included in a coverage AR2 of signals output from the wireless base station 160. The user (with the portable network relay device 10 and the personal computer 100) is located within the coverages AR1 and AR2 at both times t1 and t2.

As shown in the upper drawing of FIG. 5, at the time t1, the received signal strength indication determined for the wireless WAN-IF 50 is C(t1), and the received signal strength indication determined for the mobile communication IF 60 is D(t1). As shown in the lower drawing of FIG. 5, at the time t2 when the processing of step S105 is performed, the received signal strength indication determined for the wireless WAN-IF 50 is C(t2), and the received signal strength indication determined for the mobile communication IF 60 is D(t2).

The distance between the portable network relay device 10 and the wireless LAN access point device 150 at the time t2 is greater than the distance between the portable network relay device 10 and the wireless LAN access point device 150 at the time t1. The distance between the portable network relay device 10 and the wireless base station 160 at the time t2 is, on the other hand, approximately equal to the distance between the portable network relay device 10 and the wireless base station 160 at the time t1. On the assumption that there are no substantial changes in number and type of obstacles located between the portable network relay device 10 and each WAN-side IF (wireless WAN-IF 50 or mobile communication IF 60) at the time t1 and at the time t2, the variation per unit time calculated for the mobile communication IF 60 is smaller than the variation per unit time calculated for the wireless WAN-IF 50. In the illustrated example of FIG. 5, the mobile communication IF 60 is accordingly selected as the relay network IF.

As described above, the portable network relay device 10 of the first embodiment selects the network interface having the minimum variation in received signal strength per unit time out of the WAN-side IFs (i.e., wireless WAN-IF 50 and mobile communication IF 60), as the relay network IF. Even when the radio wave environment varies with motion of the portable network relay device 10, the network of the relatively stable radio wave environment can be selected to relay packets. This results in improving the stability of communication via the portable network relay device 10. The WAN-side IF for the network of the relatively stable radio wave environment is selected as the relay network IF. This reduces the possibility of failure or fault, such as failed authentication or unintentional session cutoff, during a change of the relay network IF to a newly selected WAN-side IF. Additionally, the portable network relay device 10 selects the network interface having the “minimum” variation in received signal strength per unit time, which reduces the required number of comparison operations to only once and shortens the time required for selection.

### B. Second Embodiment

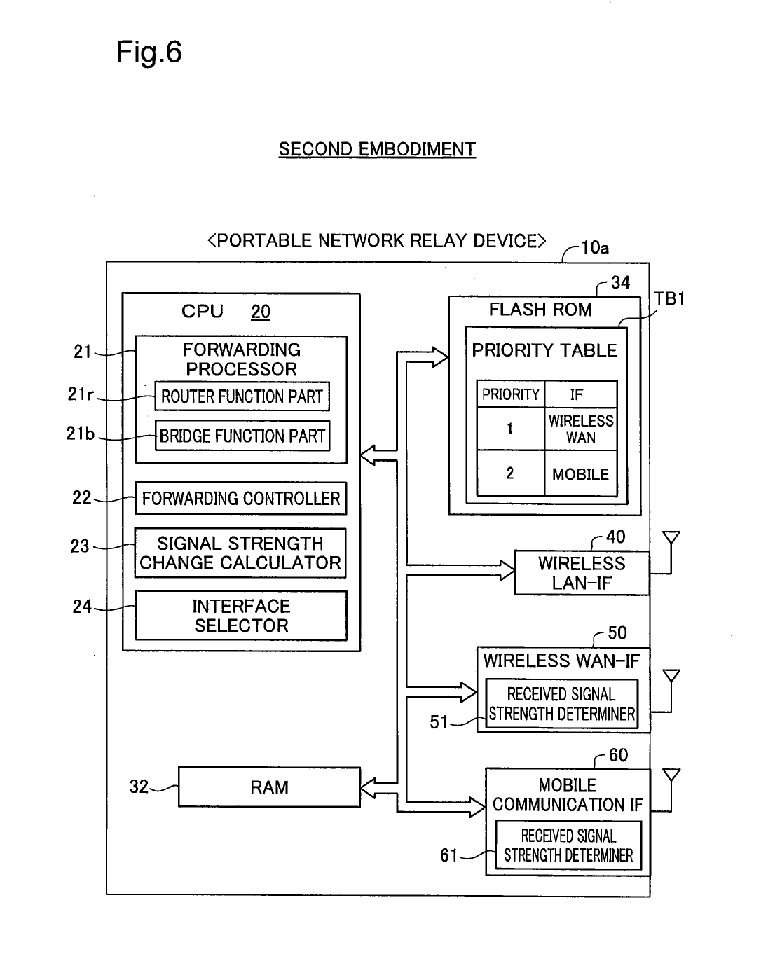

FIG. 6 is a block diagram illustrating the configuration of a portable network relay device 10a according to a second embodiment. The configuration of the portable network relay device 10a of the second embodiment differs from the configuration of the portable network relay device 10 of the first embodiment by the advanced storage of a priority table TB1 in the flash ROM 34 and the basis used for selecting the relay network IF out of WAN-side IFs. The other configuration of the portable network relay device 10a is substantially the same as the configuration of the portable network relay device 10 of the first embodiment.

As illustrated in FIG. 6, the priority table TB1 has the settings of priorities with respect to the wireless WAN-IF 50 and the mobile communication IF 60. According to this embodiment, the priority “1” is set for the wireless WAN-IF 50, and the priority “2” is set for the mobile communication IF 60. The priority “1” is the higher priority than the priority “2”. The user is allowed to set the priorities according to any desired criterion. The user may arbitrarily set the priorities, for example, based on the communication rate, the power consumptions of the respective network interfaces and the communication cost.

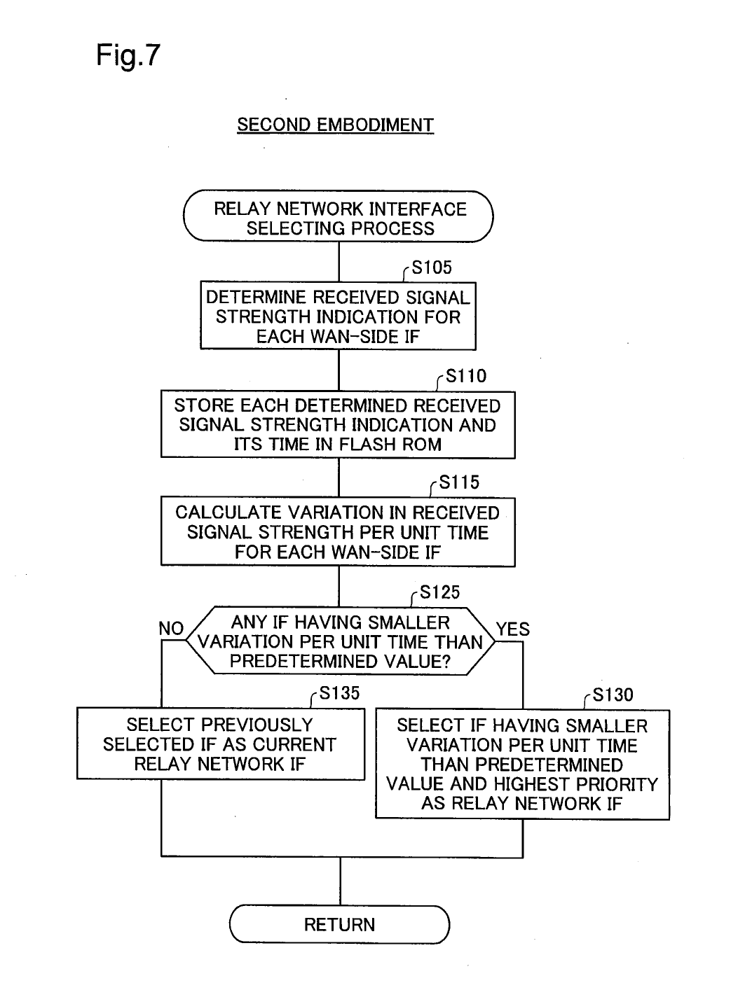

FIG. 7 is a flowchart showing a procedure of relay network interface selecting process according to the second embodiment. The relay network interface selecting process of the second embodiment differs from the relay network interface selecting process of the first embodiment shown in FIG. 3 by replacement of step S120 with steps S125, S130 and S135, but is otherwise the same as the first embodiment.

As shown in FIG. 7, after calculating the variation per unit time with respect to each WAN-side IF at step S115, the interface selector 24 determines whether there is any network interface having the calculated variation per unit time that is smaller than a predetermined magnitude or predetermined value (step S125).

When it is determined that there is any network interface having the smaller variation per unit time than the predetermined value (step S125: YES), the interface selector 24 refers to the priority table TB1 and selects a network interface having the highest priority out of the network interfaces having the smaller variation per unit time than the predetermined value, as the relay network IF (step S130). When it is determined that there is no network interface having the smaller variation per unit time than the predetermined value (step S125: NO), on the other hand, the interface selector 24 selects the previously selected network interface as the current relay network IF (step S135).

The portable network relay device 10a of the second embodiment described above selects the network interface having the smaller variation in received signal strength per unit time than the predetermined value out of the WAN-side IFs (wireless WAN-IF 50 and mobile communication IF 60), as the relay network IF. Even when the radio wave environment varies with motion of the portable network relay device 10a, the network of the relatively stable radio wave environment can be selected to relay packets sent from the personal computer 100. This results in improving the stability of communication via the portable network relay device 10a. Additionally, the network interface having the highest priority is selected as the relay network IF out of the network interfaces having the smaller variation in received signal strength per unit time than the predetermined value. The user can thus control the probabilities of the respective WAN-side IFs for selection as the relay network IF by adjusting the priorities set in the priority table TB1.

### C. Third Embodiment

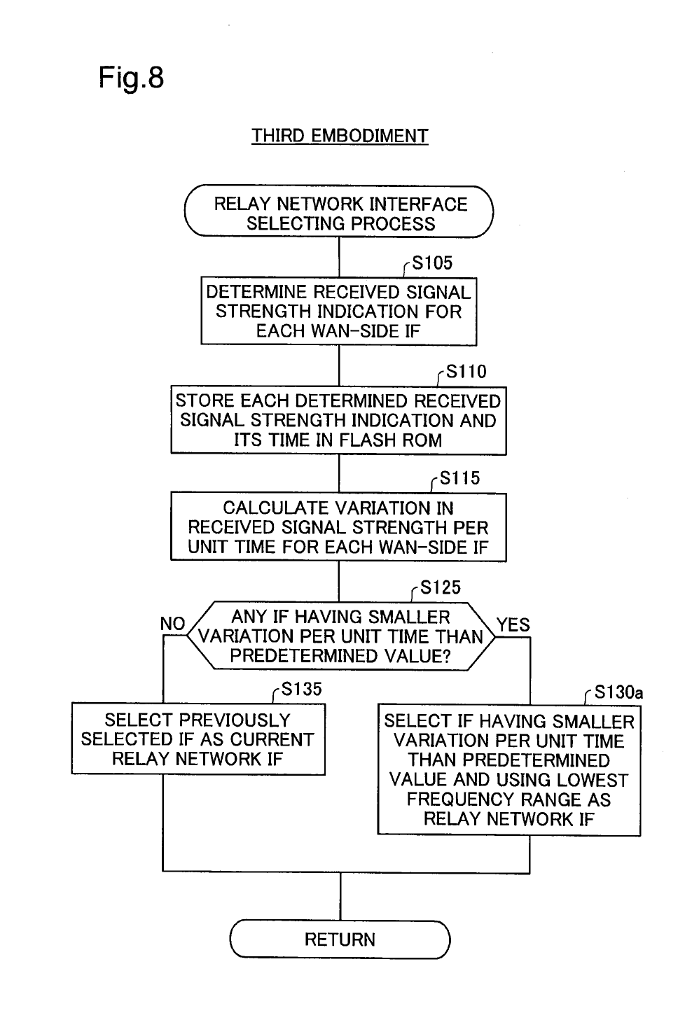

FIG. 8 is a flowchart showing a procedure of relay network interface selecting process according to a third embodiment. The configuration of a portable network relay device of the third embodiment is identical with the configuration of the portable network relay device 10 of the first embodiment. The relay network interface selecting process of the third embodiment differs from the relay network interface selecting process of the second embodiment shown in FIG. 7 by replacement of step S130 with step S130a, but is otherwise the same as the second embodiment.

As shown in FIG. 8, when it is determined that there is any network interface having the smaller variation per unit time than the predetermined value (step S125: YES), the interface selector 24 selects a network interface using the lowest frequency range out of the network interfaces having the smaller variation per unit time than the predetermined value, as the relay network IF (step S130a). More specifically, when the working frequency range of the wireless WAN-IF 50 is 2.4 GHz band and the working frequency range of the mobile communication IF 60 is 800 MHz band and when both the network interfaces 50 and 60 have the smaller variation per unit time than the predetermined value, the mobile communication IF 60 using the lower frequency range is selected as the relay network IF.

The network interface using the lowest working frequency range is selected as the relay network IF, because the lower working frequency range has the higher tolerance to the changes in number and type of obstacles and the better transmission performance and thereby ensures stable communication over a change of the obstacles.

The portable network relay device of the third embodiment described above has the similar advantageous effects to those of the portable network relay device 10 of the first embodiment and the portable network relay device 10a of the second embodiment. Additionally, the portable network relay device of the third embodiment selects the network interface using the lowest working frequency range out of the network interfaces having the smaller variation in received signal strength per unit time than the predetermined value, as the relay network IF. Even when there are changes in number and type of obstacles located between the portable network relay device and a wireless base station (e.g., wireless LAN access point device 150 or wireless base station 160) with motion of the portable network relay device, this configuration improves the stability of communication via the portable network relay device.

### D. Fourth Embodiment

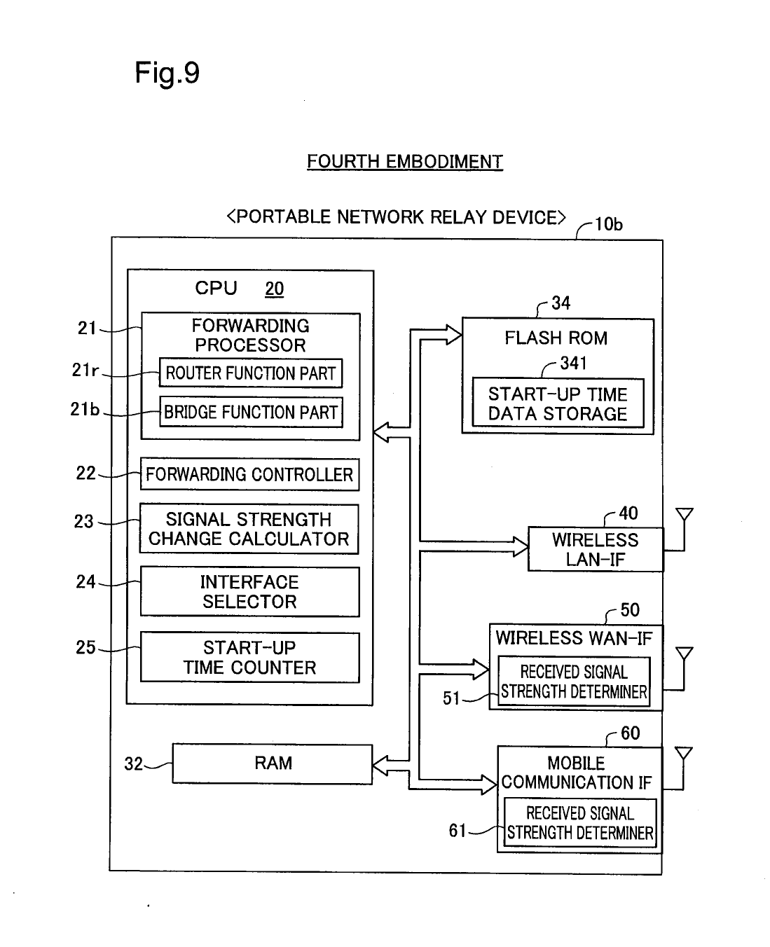

FIG. 9 is a block diagram illustrating the configuration of a portable network relay device 10b according to a fourth embodiment. The configuration of the portable network relay device 10b of the fourth embodiment differs from the configuration of the portable network relay device 10 of the first embodiment by the additional function of the CPU 20 as a start-up time counter 25 and a start-up time data storage 341 provided in the flash ROM 34. The other configuration of the portable network relay device 10b is substantially the same as the configuration of the portable network relay device 10 of the first embodiment.

The start-up time counter 25 measures or counts a time required for connection establishment sequence in each of the WAN-side IFs. More specifically, every time the connection establishment sequence is performed in each WAN-side IF to relay data output from the personal computer 100, the start-up time counter 25 counts the time from start to completion of the connection establishment sequence (to be ready for packet relay using each WAN-side IF) (hereinafter referred to as “start-up time”) and stores information on the counted start-up time as start-up time data in the start-up time data storage 341. The connection establishment sequence using the wireless WAN-IF 50 may include, for example, authentication with EESID (Extended Service Set Identifier) or WPA (Wi-Fi Protected Access) key, authentication with MAC (Media Access Control) address, PPPoE (PPP over Ethernet (registered trademark) authentication, or HTTP (HyperText Transfer Protocol)-based authentication. The start-up time counter 25 counts the start-up time including such authentication with respect to the wireless WAN-IF 50.

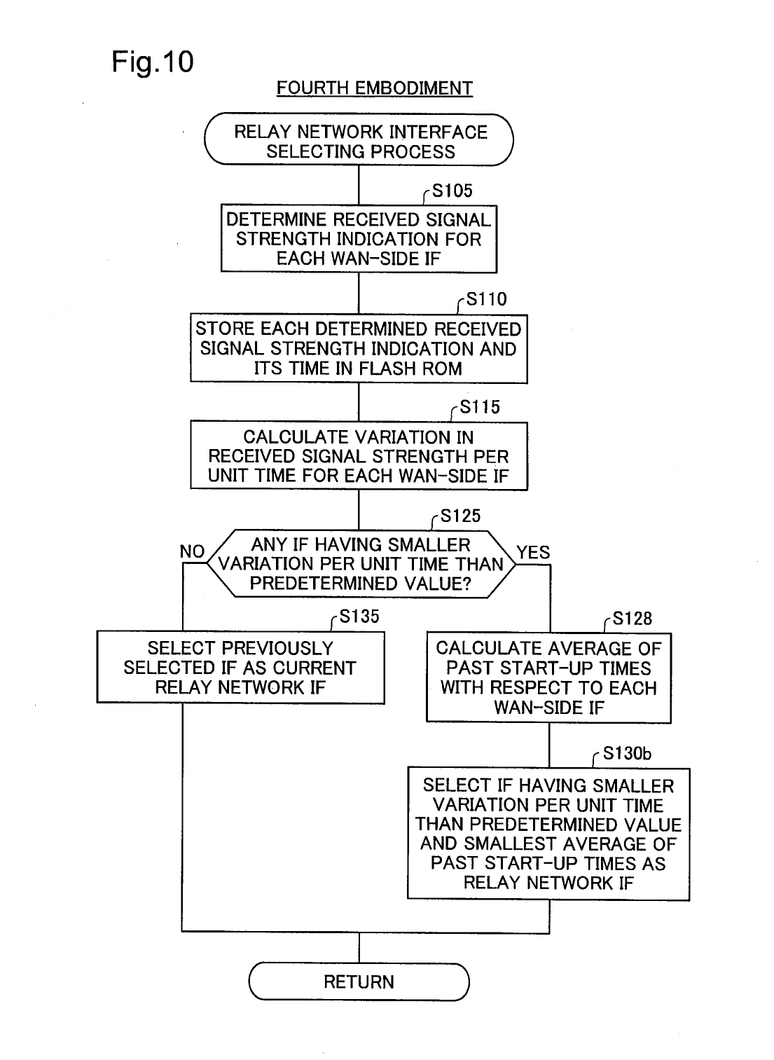

FIG. 10 is a flowchart showing a procedure of relay network interface selecting process according to the fourth embodiment. The relay network interface selecting process of the fourth embodiment differs from the relay network interface selecting process of the second embodiment shown in FIG. 7 by replacement of step S130 with steps S128 and S130b, but is otherwise the same as the second embodiment.

As shown in FIG. 10, when it is determined that there is any network interface having the smaller variation per unit time than the predetermined value (step S125: YES), the interface selector 24 reads out the start-up time data stored with respect to each of the WAN-side IFs (wireless WAN-IF 50 and mobile communication IF 60) from the start-up time data storage 341. After reading out the start-up time data, the interface selector 24 calculates an average of the past start-up times with respect to each WAN-side IF (step S128).

The interface selector 24 then selects a network interface having the smallest average of start-up time calculated at step S128 out of the network interfaces having the smaller variation per unit time than the predetermined value, as the relay network IF (step S130b).

The network interface having the smallest average of start-up time is selected as the relay network IF, because this enables the portable network relay device 10b to start forwarding of packets at the earlier timing during transmission of data from the personal computer 100.

The portable network relay device 10b of the fourth embodiment described above has the similar advantageous effects to those of the portable network relay device 10 of the first embodiment and the portable network relay device 10a of the second embodiment. Additionally, the portable network relay device 10b of the fourth embodiment selects the network interface having the smallest average of the past start-up times out of the network interfaces having the smaller variation in received signal strength per unit time than the predetermined value, as the relay network IF. This enables the portable network relay device 10b to start forwarding of packets at the earlier timing during transmission of data from the personal computer 100.

### E. Fifth Embodiment

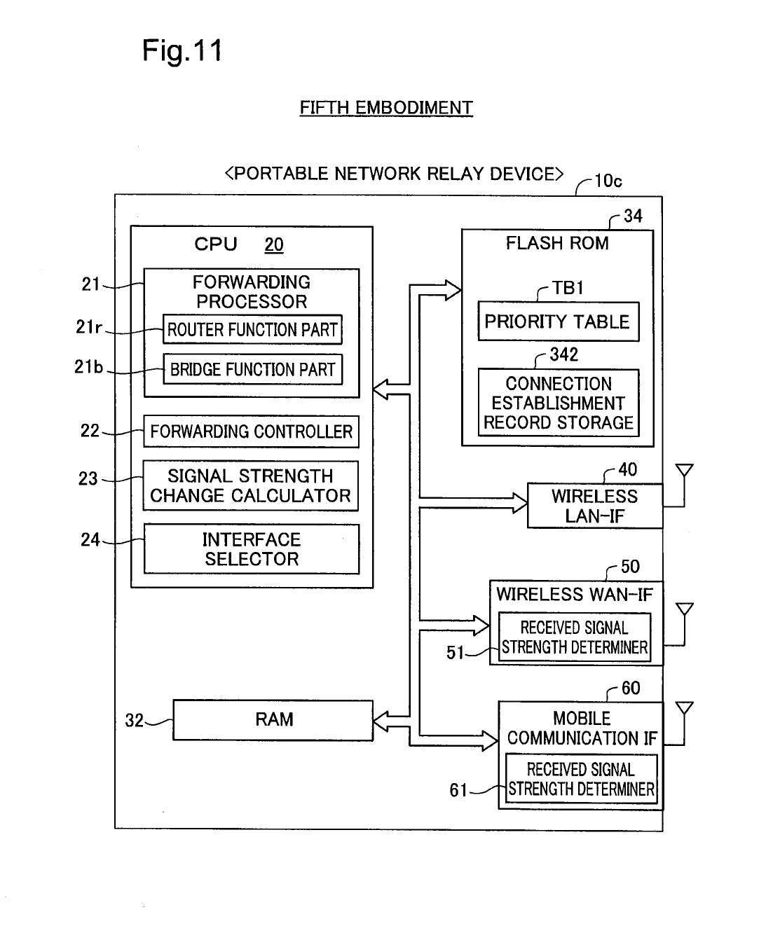

FIG. 11 is a block diagram illustrating the configuration of a portable network relay device 10c according to a fifth embodiment. The configuration of the portable network relay device 10c of the fifth embodiment differs from the configuration of the portable network relay device 10a of the second embodiment shown in FIG. 6 by a connection establishment record storage 342 provided in the flash ROM 34. The other configuration of the portable network relay device 10c is substantially the same as the configuration of the portable network relay device 10a of the second embodiment.

The connection establishment record storage 342 stores a record of success or failure of the connection establishment sequence performed in each of the WAN-side IFs. Every time the connection establishment sequence is performed, each of the wireless WAN-IF 50 and the mobile communication IF 60 stores information on success or failure of the sequence in the connection establishment record storage 342. The connection establishment sequence may be failed, for example, in the case of failed authentication due to the use of a wrong authentication key or in the case of failed transmission of authentication data to each WAN-side IF due to the deteriorating radio wave environment by obstacles located between each WAN-side IF and the portable network relay device 10c. The connection establishment record storage 342 is sometimes referred to herein as the storage.

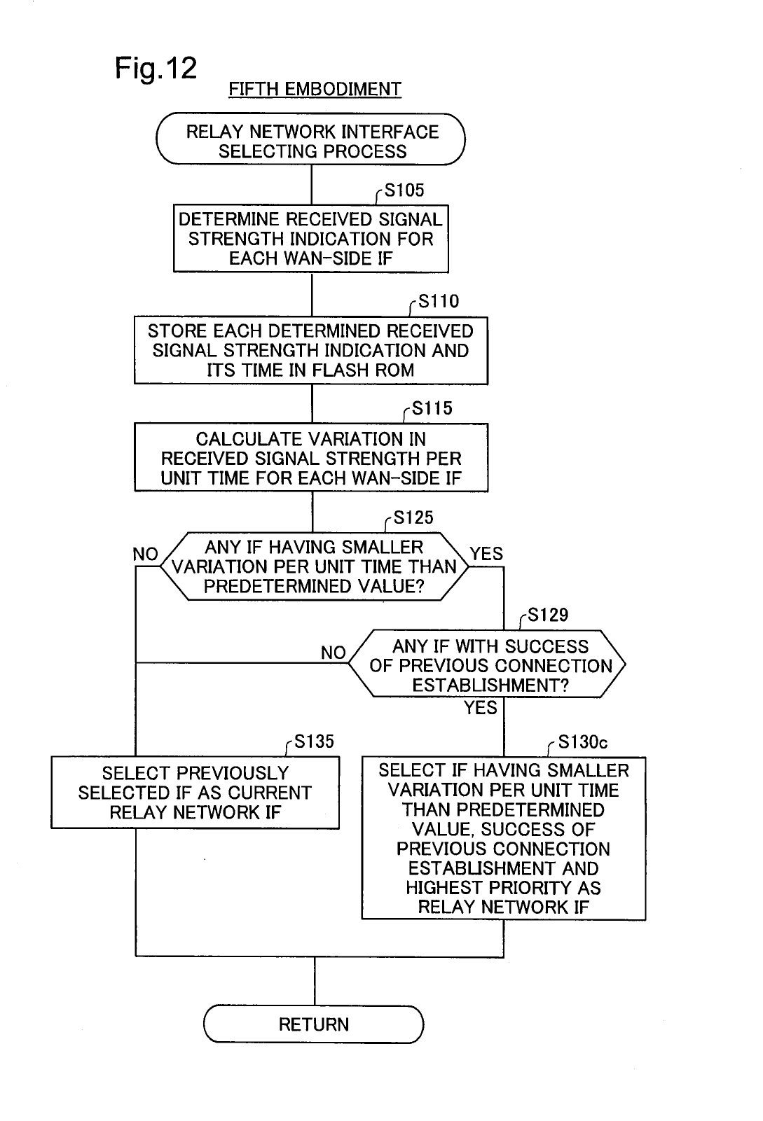

FIG. 12 is a flowchart showing a procedure of relay network interface selecting process according to the fifth embodiment. The relay network interface selecting process of the fifth embodiment differs from the relay network interface selecting process of the second embodiment shown in FIG. 7 by replacement of step S130 with steps S129 and S130c, but is otherwise the same as the second embodiment.

As shown in FIG. 12, when it is determined that there is any network interface having the smaller variation per unit time than the predetermined value (step S125: YES), the interface selector 24 refers to the connection establishment record storage 342 and determines whether there is any network interface having the smaller variation per unit time than the predetermined value and success of the previous connection establishment sequence (step S129). When it is determined that there is no network interface having the smaller variation per unit time than the predetermined value and success of the previous connection establishment sequence (step S129: NO), the interface selector 24 performs the processing of step S135 described above.

When it is determined that there is any network interface having the smaller variation per unit time than the predetermined value and success of the previous connection establishment sequence (step S129: YES), on the other hand, the interface selector 24 selects a network interface having the smaller variation per unit time than the predetermined value, success of the previous connection establishment sequence and the highest priority, as the relay network IF (step S130c). Using the network interface with success of the previous connection establishment sequence generally has the high probability of success of the current connection establishment sequence. The portable network relay device 10c accordingly selects the network interface with success of the previous connection establishment sequence as the relay network IF, so as to prevent the time required to make the portable network relay device 10 ready for packet relay since the start of the connection establishment sequence from being extended by failure of the connection establishment sequence.

The portable network relay device 10c of the fifth embodiment described above has the similar advantageous effects to those of the portable network relay device 10 of the first embodiment and the portable network relay device 10a of the second embodiment. Additionally, the portable network relay device 10c of the fifth embodiment selects the network interface with success of the previous connection establishment sequence as the relay network IF. Such selection increases the probability of success of the current connection establishment sequence. This accordingly prevents the time required to make the portable network relay device 10 ready for packet relay since the start of the connection establishment sequence from being extended by failure of the connection establishment sequence.

### F. Sixth Embodiment

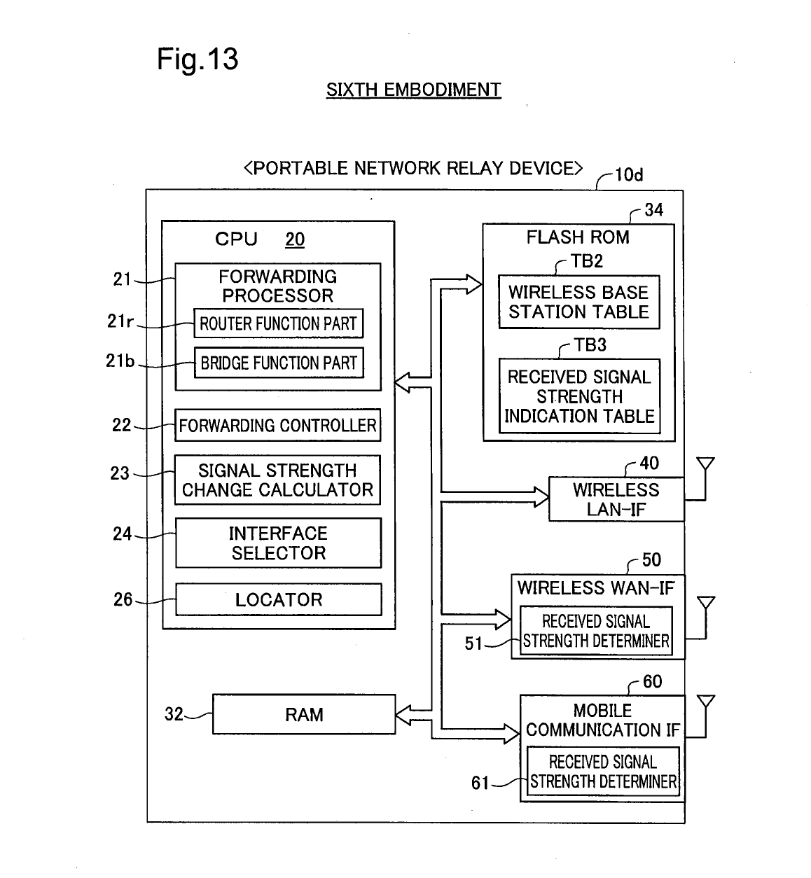

FIG. 13 is a block diagram illustrating the configuration of a portable network relay device 10d according to a sixth embodiment. The configuration of the portable network relay device 10d of the sixth embodiment differs from the configuration of the portable network relay device 10 of the first embodiment by the additional function of the CPU 20 as a locator 26, a wireless base station table TB2 and a received signal strength indication table TB3 provided in the flash ROM 34, and a method of determining the received signal strength indication in each of the WAN-side IFs. The other configuration of the portable network relay device 10d is substantially the same as the configuration of the portable network relay device 10 of the first embodiment. The locator 26 specifies the current location of the portable network relay device 10d.

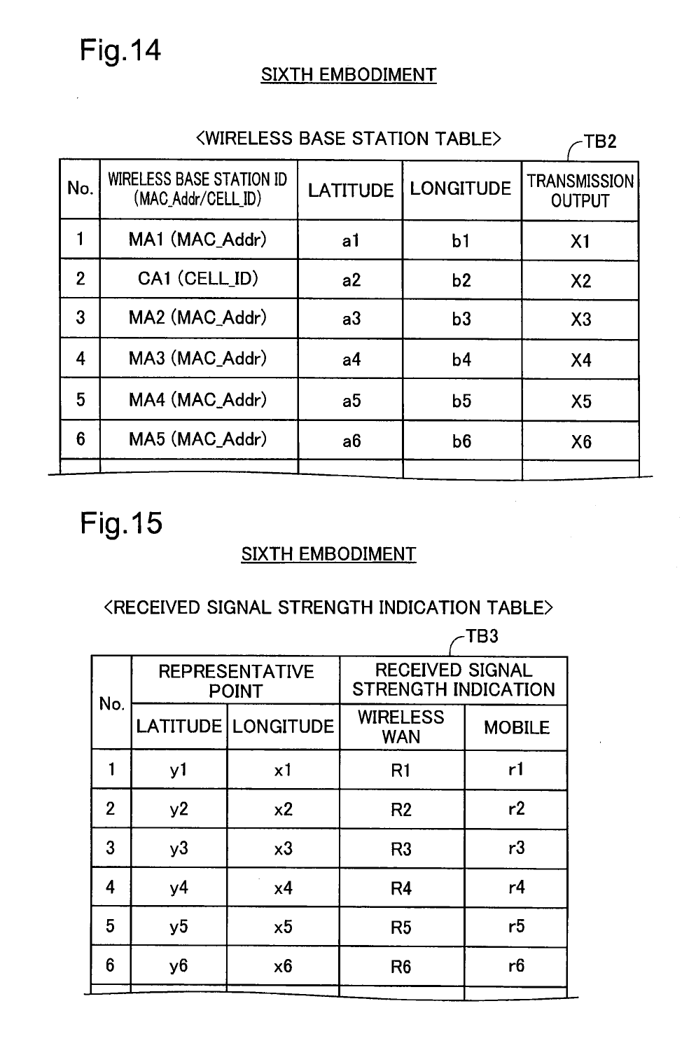

FIG. 14 illustrates one example of the settings of the wireless base station table TB2 shown in FIG. 13. The wireless base station table TB2 stores the combination of the latitude, the longitude and the transmission output in correlation to the wireless base station ID (identifier) with respect to each wireless base station. The wireless base station ID set in the wireless base station table TB2 is a MAC (Media Access Control) address for each wireless LAN access point and is a cell ID for each wireless base station of the mobile communication network. The latitude and the longitude set in the wireless base station table TB2 mean the latitude and the longitude of the location where each wireless base station is placed. The transmission output set in the wireless base station table TB2 means the transmission output of a signal from each wireless base station. For convenience of illustration, six entries (No. 1 to No. 6) are representatively illustrated in FIG. 14. For convenience of description, the respective values set in each entry are expressed by symbolic codes in FIG. 14.

The wireless base station table TB2 may be set in advance, for example, by the user. In this application, the user may obtain the identifier, the latitude, the longitude and the transmission output with respect to each of wireless base stations (wireless LAN access points and base stations of the mobile communication network) located in areas where the portable network relay device 10d may be used, and may set the obtained data in the wireless base station table TB2. In another application, the public wireless LAN service provider may provide a database storing the combination of the latitude, the longitude and the transmission output in correlation to the identifier (MAC address) of each wireless LAN access point and may open up this database to the user. In this application, the user may access this database to download information on part of the stored wireless LAN access points (e.g., wireless LAN access points located in the areas where the portable network relay device 10d may be used) or information on all of the stored wireless LAN access points to the portable network relay device 10d and may set the downloaded information in the wireless base station table TB2. In yet another application, the telecommunications carrier with the mobile communication network may provide a database storing the combination of the latitude, the longitude and the transmission output in correlation to the identifier (cell ID) of each wireless base station and may open up this database to the user. In this application, information on part or all of the stored wireless base stations may similarly be set in the wireless base station table TB2.

FIG. 15 illustrates one example of the settings of the received signal strength indication table TB3 shown in FIG. 13. The received signal strength indication table TB3 stores the received signal strength indication of each of the WAN-side IFs (i.e., wireless WAN-IF 50 and mobile communication IF 60) in correlation to the location information (latitude and longitude) with respect to each of specified representative points. For convenience of description, the location information of the respective representative points and the received signal strength indications are expressed by symbolic codes in FIG. 15. These data may be set in advance by the user. More specifically, the user may detect the received signal strength indications of the wireless WAN-IF 50 and the mobile communication IF 60 at each specified representative point and set the detected received signal strength indications in the received signal strength indication table TB3. In another application, the public wireless LAN service provider or the telecommunications carrier with the mobile communication network may provide a database for management of the received signal strength indications at the respective representative points and open up this database to the user. In this application, the user may access this database to obtain the location information of the representative points and the received signal strength indications and store the obtained data in the received signal strength indication table TB3.

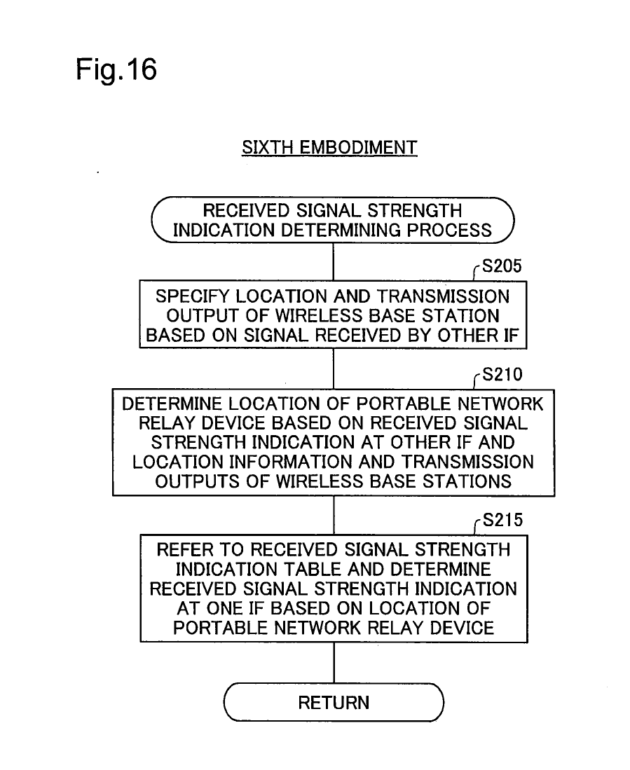

FIG. 16 is a flowchart showing a procedure of received signal strength indication determining process according to the sixth embodiment. When the portable network relay device 10d is powered on, the received signal strength indication determining process is performed repeatedly.

The locator 26 specifies the location and the transmission output of each wireless base station with respect to each WAN-side IF, based on a signal received by the other WAN-side IF (step S205). A signal output from each wireless base station includes the identifier of the wireless base station. For example, a beacon or probe response includes a MAC address of a wireless LAN access point. A signal output from each wireless base station of the mobile communication network includes a cell ID. The locator 26 searches the wireless base station table TB2 with the identifier (MAC address or cell ID) of a wireless base station included in each received signal as the key and specifies the location (latitude and longitude) and the transmission output of the wireless base station. The locator 26 specifies the locations of at least three wireless base stations, based on the signals output from the at least three wireless base stations.

The locator 26 subsequently determines the location of the portable network relay device 10d with respect to each WAN-side IF, based on the received signal strength indications at the other WAN-side IF and the locations and the transmission outputs of the respective wireless base stations specified at step S205 (step S210). More specifically, with respect to each of the wireless base stations subjected to specification of the location and the transmission output at step S205, the locator 26 first determines the power decay (space transmission loss) from the wireless base station to the portable network relay device 10d, based on the transmission output and the received signal strength indication determined at step S105 in the relay network interface selecting process. One exemplary procedure may provide in advance a table including the received power in correlation to the received signal strength indication and refer to this table to specify the received power correlated to the determined received signal strength indication. The procedure may then subtract the transmission output (transmitted power) from the received power to determine the power decay (space transmission loss). On the assumption that there is fixed radio wave environment (e.g., the number and the type of obstacles) located between each wireless base station and the portable network relay device 10d, the greater power decay is expected for the greater distance between the wireless base station and the portable network relay device 10d. The locator 26 subsequently calculates a ratio of power decays determined with respect to a combination of any two wireless base stations selected among the wireless base stations subjected to the specification of the location and the transmission output and sets a first straight line of the candidate positions for the current location of the portable network relay device 10d, based on the calculated ratio of the power decays and the location information (latitudes and longitudes) of the two selected wireless base stations. One exemplary procedure may provide in advance a table including the ratio of distances from two points in correlation to the ratio of power decays, refer to this table to specify the ratio of distances from two points correlated to the ratio of power decays, and set a straight line satisfying the ratio of distances from the positions of the two wireless base stations equal to the specified ratio of distances as the first straight line. Similarly the locator 26 calculates a ratio of power decays determined with respect to a different combination of two other wireless base stations and sets a second straight line of the candidate positions for the current location of the portable network relay device 10d, based on the calculated ratio of power decays and the location information (latitude and longitude) of the two other wireless base stations. The locator 26 then specifies an intersection (latitude and longitude) of the first straight line with the second straight line and determines this specified intersection as the current location of the portable network relay device 10d.

When there are two wireless base stations subjected to the specification of the location and the transmission output at step S205, the procedure may set the first straight line as described above, obtain an intersection of a straight line connecting the two wireless base stations with the first straight line and determine this intersection as the current location of the portable network relay device 10d. When there is only one wireless base station subjected to the specification of the location and the transmission output, on the other hand, the procedure may determine a position apart from the wireless base station by a predetermined distance in a predetermined direction, as the current location of the portable network relay device 10d.

The locator 26 refers to the received signal strength indication table TB3 and determines the received signal strength indication of each WAN-side IF, based on the current location of the portable network relay device 10d determined at step S210 (step S215). More specifically, the locator 26 may refer to the received signal strength indication table TB3 to specify a representative point at the closest position to the current location of the portable network relay device 10d determined at step S210, and may determine the received signal strength indication at each WAN-side IF set at the specified representative point as the received signal strength indication of one WAN-side IF (i.e., different WAN-side IF from the other WAN-side IF having the received signal strength indication referred to at step S210).

The following describes one specific example of determining the received signal strength indication of the wireless WAN-IF 50 by this received signal strength indication determining process. At step S205, the procedure specifies the location and the transmission output of a wireless base station in the mobile communication network, based on the received signal strength indication at the mobile communication IF 60 that is the other WAN-side IF. At step S210, the procedure determines the location of the portable network relay device 10d, based on the received signal strength indication at the mobile communication IF 60 and the specified location and transmission output of the wireless base station in the mobile communication network. At step S215, the procedure specifies a representative point closest to the determined location of the portable network relay device 10d and determines the received signal strength indication at the wireless WAN-IF 50 set at the specified representative point (e.g., received signal strength indication “R1” when the NO. 1 position shown in FIG. 15 is specified as the representative point).

The received signal strength indication of each WAN-side IF is determined by using the received signal strength indication of the other WAN-side IF. This enables determination of the received signal strength indication with high accuracy even in the poor radio wave environment and in the state that the received signal strength indication determined by the received signal strength determiner 51 or the received signal strength determiner 61 may have low accuracy. In one example of such state, there are lots of obstacles between the wireless LAN access point device 150 and the portable network relay device 10d, which leads to the extremely low received signal strength and makes it difficult to measure the received signal strength by the wireless WAN-IF 50 with high accuracy.

The portable network relay device 10d of the sixth embodiment described above has the similar advantageous effects to those of the portable network relay device 10 of the first embodiment. Additionally, the portable network relay device 10d determines the received signal strength indication at each WAN-side IF by using the received signal strength indication determined by the received signal strength determiner of the other WAN-side IF. This enables determination of the received signal strength indication with high accuracy even in the poor radio wave environment of communication using one WAN-side IF and in the state that the received signal strength indication determined by the received signal strength determiner of one WAN-side IF (i.e., received signal strength determiner 51 or received signal strength determiner 61) may have low accuracy.

### G. Seventh Embodiment

The above first to the sixth embodiments describe application of the portable network communication device of the disclosure to the portable network relay device (mobile router), but a seventh embodiment describes application of the portable network communication device of the disclosure to a cell phone device.

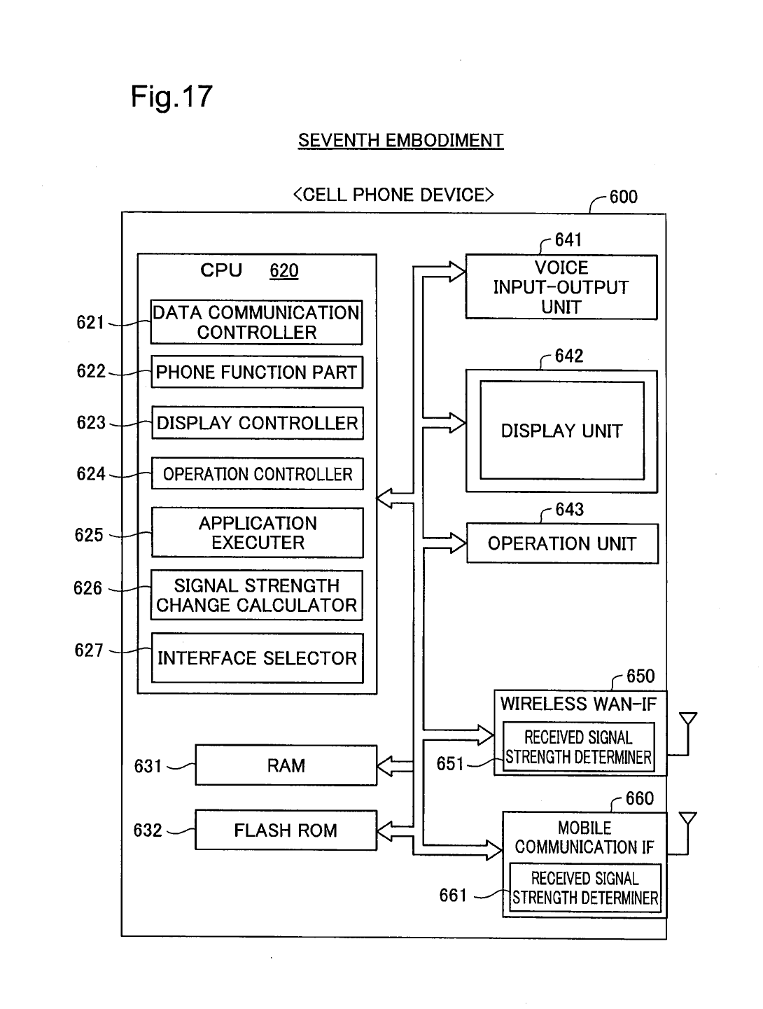

FIG. 17 is a block diagram illustrating the configuration of a cell phone device 600 as one embodiment of the portable network communication device of the disclosure. The cell phone device 600 includes a wireless WAN-IF 650, a mobile communication IF 660, a CPU 620, a flash ROM 632, a RAM 631, a voice input-output unit 641, a display unit 642 and an operation unit 643. The cell phone device 600 can serve as a conventional telephone set to establish voice communication with another telephone set. The cell phone device 600 can also serve as a data communication terminal to establish data communication with, e.g., a device connected to the Internet.

The CPU 620 of the seventh embodiment differs from the CPU 20 of the first embodiment by the functions as a data communication controller 621, a phone function part 622, a display controller 623, an operation controller 624 and an application executer 625, in place of the forwarding processor 21 and the forwarding controller 22.

The data communication controller 621 controls data communication established via a network by the cell phone device 600. For example, when an application executed by the cell phone device 600 is accompanied with TCP/IP (Transmission Control Protocol/Internet Protocol) communication between the cell phone device 600 and a device connected therewith via a network, the data communication controller 62 performs TCP/IP operations. More specifically, the data communication controller 621 sends and receives layer 3 packets according to a routing table stored in the flash ROM 632. The data communication controller 621 of the seventh embodiment is sometimes referred to as the communication processor.

The phone function part 622 performs various operations to enable the phone functions, such as call connection, call clearing, voice encoding and denoising. The display controller 623 controls the image display (e.g., displaying a WEB page obtained by application execution) on the display unit 642. The operation controller 624 interprets input information from the operation unit 643 and transmits the results of interpretation to the other function parts 621 to 623 and 625. The application executer 625 executes an application according to application software stored in the flash ROM 632.

The CPU 620 of the seventh embodiment works as the respective function parts 621 to 625 described above and further serves as a signal strength change calculator 626 and an interface selector 627. The signal strength change calculator 626 of the seventh embodiment has the same functions as those of the signal strength change calculator 23 of the first embodiment and is thus not specifically described here. Similarly, the interface selector 627 of the seventh embodiment has the same functions as those of the interface selector 24 of the first embodiment and is thus not specifically described here.

The voice input-output unit 641 includes a microphone and a speaker and serves to generate a voice signal based on the input voice and reproduce the voice based on the voice signal. The display unit 642 displays an operation menu screen and a still image or a moving image obtained as the result of application execution. The display unit 642 may be, for example, a touch-panel liquid crystal display. The operation unit 643 has various operation buttons, e.g., buttons operable to adjust the sound volume and buttons operable to move the cursor position on the display unit 642.

The wireless WAN-IF 650 of the seventh embodiment has the same functions as those of the wireless WAN-IF 50 of the first embodiment and is thus not specifically described here. Similarly, the mobile communication IF 660, the RAM 631 and the flash ROM 632 respectively have the same functions as those of the mobile communication IF 60, the RAM 32, and the flash ROM 34 of the first embodiment and are thus not specifically described here.

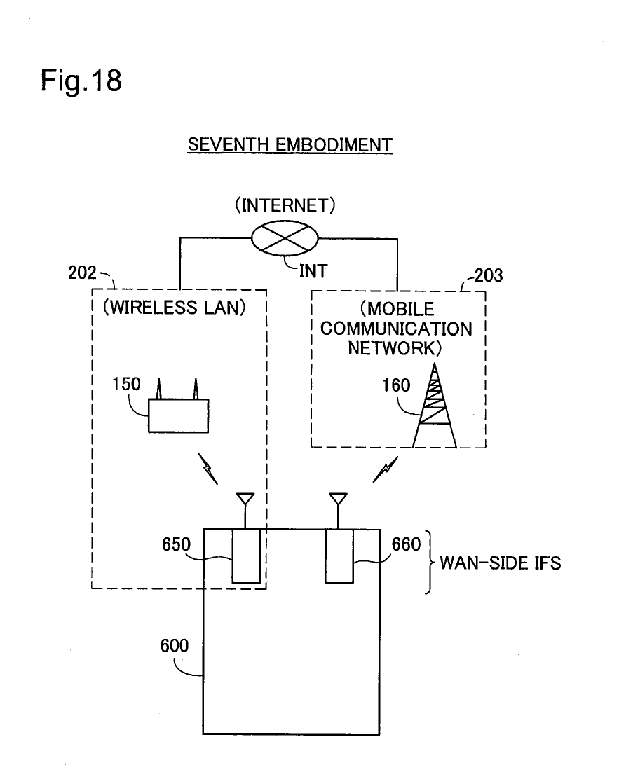

FIG. 18 schematically illustrates a communication mode using the cell phone device according to the seventh embodiment. The communication mode of FIG. 18 differs from the communication mode of the first embodiment shown in FIG. 2 by the absence of the structure to be connected with a communication terminal. The other structures in the communication mode of FIG. 18 are substantially similar to those in the communication mode of the first embodiment. More specifically, the cell phone device 600 does not have a terminal-side IF and does not relay data (packets) received from another communication terminal (e.g., personal computer 100 in the first embodiment) separate from the cell phone device 600 or data (packet) addressed to another communication terminal. The cell phone device 600 executes a similar application to the application executed by the personal computer 100 of the first embodiment. When this application is accompanied with communication, the cell phone device 600 uses either of the wireless WAN-IF 650 and the mobile communication IF 660 that are both WAN-side IFs (interfaces used for connection with a network) to send and receive packets.

The cell phone device 600 of the seventh embodiment performs a working network interface selecting process (described below) to select a network interface used for transmission and reception of packets between the two WAN-side IFs (wireless WAN-IF 650 and mobile communication IF 660), thereby improving the stability of communication using the cell phone device 600. Hereinafter the network interface used for transmission and reception of packets is referred to as “working network interface” or “working network IF”.

The cell phone device 600 of this embodiment is sometimes referred to as the portable network communication device. The data communication controller 621 is sometimes referred to as the communication processor.

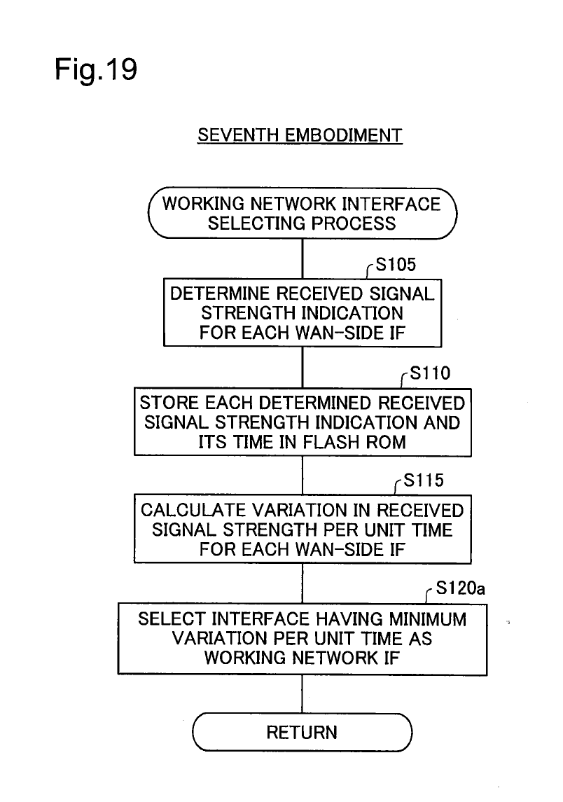

FIG. 19 is a flowchart showing a procedure of working network interface selecting process according to the seventh embodiment. The working network interface selecting process of the seventh embodiment differs from the relay network interface selecting process of the first embodiment shown in FIG. 3 by replacement of step S120 with step S120a. Otherwise the working network interface selecting process of the seventh embodiment is similar to the relay network interface selecting process of the first embodiment.

After executing the processes at steps S105 to S115 as described previously, the interface selector 627 selects a network interface having the minimum variation per unit time out of the WAN-side IFs as the working network IF, based on the variations per unit time calculated at step S115 (step S120a). The process of step S120a differs from the process of step S120 by selecting the “working network IF” in place of the “relay network IF”, but has substantially the same process details as those of step S120.

After selecting the working network IF, the data communication controller 621 registers the selected working network IF in a routing table. As a result, the network interface (wireless WAN-IF 650 or mobile communication IF 660) selected as the working network IF is used for communication between the cell phone device 600 and a device connected to the Internet INT.

The cell phone device 600 of the seventh embodiment described above has the similar advantageous effects to those of the portable network relay device 10 of the first embodiment. More specifically, even when the radio wave environment varies with motion of the cell phone device 600, this procedure selects the network of the relatively stable radio wave environment for transmission and reception of packets, thus improving the stability of communication using the cell phone device 600. The WAN-side IF for the network of the relatively stable radio wave environment is selected as the working network IF. This reduces the possibility of failure or fault, such as failed authentication or unintentional session cutoff, during a change of the working network IF to a newly selected WAN-side IF. Additionally, the cell phone device 600 selects the network interface having the “minimum” variation in received signal strength per unit time, which reduces the required number of comparison operations to only once and shortens the time required for selection.

### H. Modifications

H1. Modification 1

In the second to the fifth embodiments described above, a network interface satisfying a specified condition is selected out of the network interfaces having the smaller variation per unit time than the predetermined value, as the relay network IF or the working network IF, but the specified condition is not limited to those described in these respective embodiments. For example, the specified condition may be selecting a network interface for a wireless base station having the widest coverage out of the WAN-side IFs as the relay network IF or the working network IF. Even when any of the portable network relay devices 10a to 10c and the cell phone device 600 is moved, this condition increases the possibility that the portable network relay device 10a to 10c or the cell phone device 600 is present in the same coverage, thus improving the stability of communication using the portable network relay device 10a to 10c or the cell phone device 600.

One exemplary procedure may provide and store in advance a table storing information on the coverage (e.g., receivable distance from the wireless base station) with respect to each base station in the flash ROM 34 or 632 and refer to this table to specify the coverage. When a beacon output from the wireless LAN access point device 150 includes information on the coverage, the procedure may specify the coverage of a wireless LAN based on this information. The coverage of the mobile communication network may be specified by the following procedure. The procedure may select an optimum transmission output between the wireless base station 160 and the mobile communication IF 60 or 660 according to a specified feedback algorithm. The procedure may provide and store in advance a table correlating the transmission output to the information on the coverage (e.g., receivable distance from the wireless base station 160) in the flash ROM and refer to this table to specify the coverage correlated to the selected transmission output. This table is set such that the greater transmission output gives the wider coverage. The CPU 20 executes a program stored in advance in the flash ROM 34 to serve as the function part for specifying the coverage, and this function part is sometimes described herein as the coverage specifier.

H2. Modification 2

The procedure of the sixth embodiment specifies the location of the portable network relay device 10d based on the received signal strength indication at the WAN-side IF and the locations and the transmission outputs of wireless base stations specified at step S205, but the disclosure is not limited to this procedure. For example, the locator 26 may have a GPS (Global Positioning System) receiver and receive GPS signals (positioning signals) sent from GPS satellites (positioning satellites) to specify the location of the portable network relay device 10d. The location of the portable network relay device 10d may be specified by using another satellite positioning system but GPS, for example, QZSS (Quasi-Zenith Satellite System).

H3. Modification 3

In the first to the sixth embodiments, wireless connection using the wireless LAN-IF 40 is employed for connection of the portable network relay device 10, 10a to 10d with the personal computer 100. The wireless connection may, however, be replaced with wired connection. In the latter configuration, the portable network relay device 10, 10a to 10d may be provided with a network interface for wired connection, which is connected with the personal computer 100 by a network cable. The network interface for wired connection may be, for example, a network interface conforming to IEEE802.3ab or IEEE802.3au.

H4. Modification 4

The relay network IF or the working network IF is selected based on the variation in received signal strength per unit time in the above respective embodiments, but the disclosure is not limited to this basis of selection. For example, the relay network IF or the working network IF may be selected, based on a “change rate” in received signal strength per unit time, in place of the “variation” in received signal strength per unit time. More specifically, like the above embodiments, the procedure may calculate the absolute value of the difference between the previous received signal strength indication and the current received signal strength indication and divide the calculated absolute value of the difference by the absolute value of the current received signal strength indication, so as to obtain a change rate in received signal strength indication. The network interface having the minimum change rate may be selected as the relay network IF or the working network IF. Alternatively the network interface satisfying the condition described in each of the second to the fifth embodiments may be selected out of the network interfaces having the smaller change rate than a predetermined value as the relay network IF or the working network IF. In this modified configuration, the change rate in received signal strength indication is not divided by the time interval between determination of the previous received signal strength indication and determination of the current received signal strength indication. The relay network IF selecting process is, however, performed simultaneously with respect to the respective WAN-side IFs and thereby allows a comparison between the change rates of the respective WAN-side IFs during the same time interval, which is substantially equivalent to a comparison between the change rates per unit time. Such division can be omitted in the respective embodiments, because of this reason. In general, the disclosure may employ any value of change representing the magnitude of change in received signal strength per unit time, as the information used to select the relay network IF or the working network IF.

H5. Modification 5

The network interface having the smaller variation per unit time than the predetermined value and the smallest average of the past start-up times is selected as the relay network IF at step S130b in the fourth embodiment, but the disclosure is not limited to such selection. For example, a network interface having the smaller variation per unit time than the predetermined value and the shortest of the previously measured start-up times may be selected as the relay network interface IF. This modified configuration can omit the process of step S128 and thereby reduce the total time required for the relay network IF selecting process. It is highly probable that the communication environment (e.g., radio wave environment and the operating status of the authentication server) during previous measurement of the start-up time is similar to the communication environment in current establishment of connection. The current start-up time for establishment of connection is thus likely to be close to the previously measured start-up time. Selecting the network interface having the shortest of the previously measured start-up times as the relay network IF results in selecting the network interface that is likely to have the start-up time substantially equivalent to the start-up time for current establishment of connection. This enables packet relay to start at the earlier timing during transmission of data from the personal computer 100.

H6. Modification 6

In the first to the sixth embodiments, the relay network interface selecting process is performed repeatedly when the portable network relay device 10 or 10a to 10d is powered on. In the seventh embodiment, the working network interface selecting process is performed repeatedly when the cell phone device 600 is powered on. The timing and the frequency of performing the selecting process according to the disclosure are, however, not limited to these embodiments. One exemplary procedure may monitor the received signal strength indication any time or at regular intervals and may perform the relay network interface selecting process or the working network interface selecting process when the received signal strength indication has a change of or above a specified level. In this manner, the relay network interface selecting process or the working network interface selecting process may be triggered by any arbitrary event that affects the relay network interface selecting process or the working network interface selecting process, such as a change in received signal strength indication or replacement of the WAN-side IF. The relay network interface selecting process of the first embodiment may be configured to start and terminate one cycle (steps S105 to S120) at predetermined time intervals (e.g., every 100 milliseconds). Similarly the working network interface selecting process of the seventh embodiment may be configured to start and terminate one cycle (steps S105 to S120a) at predetermined time intervals. In another example, the relay network IF selecting process in any of the first to the sixth embodiments may be triggered by sending data from the personal computer 100 to the Internet INT and receiving a packet including the sent data at the portable network relay device 10 or 10a to 10d. In this configuration, the received signal strength indication determining process of the sixth embodiment may also be triggered by such sending and receiving. Similarly the working network interface selecting process of the seventh embodiment may be triggered by sending data from the cell phone device 600 to the Internet INT.

H7. Modification 7

In the fifth embodiment, the received signal strength indication of each WAN-side IF (wireless WAN-IF 50 or mobile communication IF 60) is determined by using the received signal strength indication determined by the received signal strength determiner of the other WAN-side IF, but the disclosure is not limited to this procedure. One exemplary procedure may determine the received signal strength indication of the wireless WAN-IF 50 by using the received signal strength indication determined by the received signal strength determiner 61 of the mobile communication IF 60, while specifying the received signal strength indication determined by the received signal strength determiner 61, as the received signal strength indication of the mobile communication IF 60. Another exemplary procedure may determine the received signal strength indication of the mobile communication IF 60 by using the received signal strength indication determined by the received signal strength determiner 51 of the wireless WAN-IF 50, while specifying the received signal strength indication determined by the received signal strength determiner 51, as the received signal strength indication of the wireless WAN-IF 50.

H8. Modification 8

The configurations of the portable network relay devices 10 and 10a to 10d and the cell phone device 600 described in the respective embodiments are only illustrative and may be modified and altered in various ways. For example, the wireless LAN-IF 40 and the wireless WAN-IF 50 or 650 in the respective embodiments may be any wireless communication interface that establishes wireless communication by any future-available wireless LAN, in place of the wireless LAN conforming to IEEE802.11a/b/g/n. The mobile communication IF 60 or 660 may be any wireless communication interface that establishes wireless communication by any future-available mobile communication such as LTE (Long Term Evolution), next-generation mobile WiMax (IEEE802.16m) or next-generation PHS (XGP: eXtended Global Platform), in place of the mobile communication conforming to 3G/HSPA.

There are only two WAN-side IFs in the respective embodiments: wireless WAN-IF 50 and mobile communication IF 60, but there may be three or more WAN-side IFs. This modified configuration may include a plurality of the same type of network interfaces.

In the respective embodiments, part of the hardware configuration may be replaced by software configuration, while part of the software configuration may be replaced by hardware configuration. In the application that part or all of the functions of the disclosure is implemented by the software configuration, the software (computer programs) may be provided in the form of storage in a computer readable storage medium.

The “computer readable storage medium” of the disclosure is not limited to a portable storage medium, such as flexible disk or CD-ROM, but also includes any of internal storage devices in the computer, such as various RAMS and ROMs and external storage devices fixed to the computer, such as hard disk drives. The term “computer readable storage medium” herein is used in the wider sense and includes any non-transitory, fixed storage medium.

The disclosure is not limited to the above embodiments or modifications, but various other modifications and variations may be made to the embodiments without departing from the scope of the disclosure. For example, the technical features of the above embodiments or modifications corresponding to the technical features of the respective aspects described in Summary may be replaced or combined as needed basis, in order to solve part or all of the above problems or in order to attain part or all of the advantageous effects described above. The technical features that are not specified as essential in the description hereof may be omitted as needed basis.

### I. Other Aspects

According to one exemplary embodiment, a portable network communication device is provided. The portable network communication device, comprises a plurality of first network interfaces that establish wireless communication with wireless base stations respectively belonging to different wireless networks; a communication controller that sends and receives a packet via one of the plurality of first network interfaces; a received signal strength determiner that determines received signal strength of a signal received from each of the wireless base stations with respect to each of the first network interfaces; a signal strength change calculator that calculates a value of change representing magnitude of a change in determined received signal strength per unit time with respect to each of the first network interfaces; and an interface selector that selects a working network interface that is the first network interface used to send and receive the packet, among the plurality of first network interfaces, based on the calculated value of change. The portable network communication device of this aspect selects the working network interface, based on the magnitude of change in received signal strength per unit time. Even when the strength of the radio signal sent to and received from the wireless base station changes with a change in location of the portable network communication device, the first network interface that allows the more stable communication can thus be selected as the working network interface. This accordingly improves the stability of communication using the portable network communication device.

According to one aspect of the embodiment, the interface selector selects one of the plurality of first network interfaces having a smallest value of change among the plurality of first network interfaces, as the working network interface. According to this aspect, the first network interface that has the smallest change in received signal strength per unit time and is thereby provided for the wireless network allowing most stable communication can thus be selected as the working network interface. Additionally, selecting the first network interface for wireless network allowing most stable communication as the working network interface advantageously reduces the possibility of failure or fault, such as failed authentication or unintentional session cutoff, during a change of the working network interface to a newly selected first network interface.

According to another aspect, the interface selector selects one of the plurality of first network interfaces having smaller values of change than a predetermined value, as the working network interface. According to this aspect, the first network interface that has the relatively small change in received signal strength per unit time and is thereby provided for the wireless network allowing relatively stable communication can thus be selected as the working network interface.

According to another aspect, a priority is set to each of the plurality of first network interfaces, and the interface selector selects one of the plurality of first network interfaces having a smaller value of change than a predetermined value and a highest priority among the plurality of first network interfaces, as the working network interface. According to this aspect, the probability of each of the first network interfaces for selection as the working network interface can be controlled by adjusting the priority set to each of the first network interfaces.

According to another aspect, the interface selector selects one of the plurality of first network interfaces having a smaller value of change than a predetermined value and using a lowest frequency range among the plurality of first network interfaces, as the working network interface. The configuration of this aspect can establish communication between the portable network communication device and the wireless base station by using the frequency range of the relatively high tolerance to the change of obstacles and the relatively good transmission performance.

According to another aspect, the portable network communication device further comprises a start-up time counter that counts a start-up time that is a time interval between start and end of a specific process for connection establishment in wireless communication using each of the first network interfaces, wherein each of the first network interfaces performs the specific process with a corresponding wireless network, and the interface selector selects one of the plurality of first network interfaces having a smaller value of change than a predetermined value and a shortest start-up time among the plurality of first network interfaces, as the working network interface. The configuration of this aspect enables a communication terminal that is different from the portable network communication device to start communication via the portable network communication device within a relatively short time. This configuration also enables the portable network communication device itself as a communication terminal to start communication within a relatively short time.

According to another aspect, the portable network communication device further comprises a storage that stores information representing result of a specific process for connection establishment in wireless communication using each of the first network interfaces, wherein the interface selector selects one of the plurality of first network interfaces having a smaller value of change than a predetermined value and a record of successful result in the storage, as the working network interface. The configuration of this aspect reduces the possibility of failure of the specific process for connection establishment when a communication terminal that is different from the portable network communication device tries to start communication via the portable network communication device. This configuration also reduces the possibility of failure of the specific process for connection establishment when the portable network communication device itself as a communication terminal tries to start communication. This accordingly prevents the time period required to be ready for start of communication of the communication terminal or the portable network communication device from being undesirably extended.

According to another aspect, the portable network communication device further comprises a coverage specifier that specifies a coverage of signal sent from each of the wireless base stations, with respect to each of the wireless base stations, wherein the interface selector selects one of the plurality of first network interfaces having a smaller value of change than a predetermined value and being provided for a wireless network that the wireless base station having a widest coverage belongs to, among the plurality of first network interfaces, as the working network interface. The configuration of this aspect increases the possibility that the portable network connection device is present in the same coverage even when the portable network communication device is moved, thus improving the stability of communication via the portable network communication device.

According to another aspect, the portable network communication device further comprises a locator that uses at least one of the first network interfaces to specify location information of the portable network communication device, wherein the received signal strength determiner determines received signal strength of at least one of the first network interfaces, based on the location information specified by using another first network interface. Even in the poor radio wave environment during communication using at least one of the first network interfaces, which may result in lowered accuracy of the received signal strength indication determined by the received signal strength determiner with respect to the first network interface, the configuration of this embodiment ensures determination of the received signal strength indication with high accuracy.

According to another aspect, the portable network communication device further comprises a second network interface that establishes wireless communication or wired communication with a communication terminal, wherein the communication controller relays a packet between the working network interface and the second network interface, and the interface selector selects one of the plurality of first network interfaces to be used as the working network interface to relay a packet to and from the second network interface. The configuration of this aspect improves the stability of communication via the portable network communication device that is configured to relay data (packets) received from a communication terminal via the second network interface to one of the first network interfaces.

All the plurality of elements included in each aspect or embodiment of the disclosure described above are not essential, but part of the plurality of elements may be changed, deleted, replaced with other elements or modified for partial omission of the restrictions, in order to solve part or all of the problem described above or in order to achieve part or all of the advantageous effects described herein. Part or all of the technical features included in each aspect or embodiment of the disclosure described above may be combined with part or all of the technical features included in another aspect or embodiment of the disclosure described above to provide another independent aspect or embodiment of the disclosure, in order to solve part or all of the problem described above or in order to achieve part or all of the advantageous effects described herein.

For example, one aspect of the disclosure may be provided as a device that includes at least one element among four elements, i.e., an interface, a controller, a determiner and a selector. In other words, this device may be provided with or without the interface. The device may also be provided with or without the controller. The device may further be provided with or without the determiner. The device may also be provided with or without the selector. The interface may be provided as a plurality of first network interfaces that establish wireless communication with wireless base stations respectively belonging to different wireless networks. The processor may be provided as a communication controller that sends and receives a packet via one of the plurality of first network interfaces. The determiner may be provided as a received signal strength determiner that determines received signal strength of a signal received from each of the wireless base stations with respect to each of the first network interfaces. The selector may be provided as an interface selector that selects a working network interface that is the first network interface used to send and receive the packet, among the plurality of first network interfaces, based on the determined received signal strength indication. This device may be provided, for example, as a portable network communication device or a different device other than the portable network communication device. This aspect solves at least one of the various problems, such as stabilization of communication, improvement of throughput, improvement of reliability and reduction of power consumption. Part or all of the technical features of the portable network communication device described above may be applied to this device.

The disclosure may be implemented by diversity of aspects, for example, a wireless communication system including a portable network communication device, a portable network relay device, a cell phone device, a control method of any of these devices and the system, a computer program configured to implement the functions of any of these devices and the system, and a storage medium in which such a computer program is recorded.

What is claimed is:

1. A portable network communication device, comprising:
a plurality of first network interfaces that establish wireless communication with wireless base stations respectively belonging to different wireless networks;
a communication controller that sends and receives a packet via one of the plurality of first network interfaces;
a received signal strength determiner that determines a received signal strength of a signal received from each of the wireless base stations via each of the plurality of first network interfaces;
a signal strength change calculator that calculates a value of change representing a magnitude of a change in determined received signal strength per unit time with respect to each of the plurality of first network interfaces; and
an interface selector that selects a active network interface that is a first network interface used to send and receive the packet, among the plurality of first network interfaces, based on the value of change calculated by the signal strength calculator.

2. The portable network communication device according to claim 1, wherein
the interface selector selects as the active network interface one of the plurality of first network interfaces having a smallest value of change among the plurality of first network interfaces.

3. The portable network communication device according to claim 1, wherein
the interface selector selects as the active network interface one of the plurality of first network interfaces having a smaller value of change than a predetermined value.

4. The portable network communication device according to claim 1, wherein
a priority is set to each of the plurality of first network interfaces, and
the interface selector selects as the active network interface one of the plurality of first network interfaces having a smaller value of change than a predetermined value and a highest priority among the plurality of first network interfaces.

5. The portable network communication device according to claim 1, wherein
the interface selector selects as the active network interface one of the plurality of first network interfaces having a smaller value of change than a predetermined value and using a lowest frequency range among the plurality of first network interfaces.

6. The portable network communication device according to claim 1, further comprising:
a start-up time counter that counts a start-up time that is a time interval between start and end of a specific process for connection establishment in wireless communication using each of the plurality of first network interfaces, wherein
each of the plurality of first network interfaces performs the specific process with a corresponding wireless network, and
the interface selector selects as the active network interface one of the plurality of first network interfaces having a smaller value of change than a predetermined value and a shortest start-up time among the plurality of first network interfaces.

7. The portable network communication device according to claim 1, further comprising:
a storage that stores information representing a result of a specific process for connection establishment in wireless communication using each of the plurality of first network interfaces, wherein
the interface selector selects as the active network interface one of the plurality of first network interfaces having a smaller value of change than a predetermined value and a record of successful result in the storage.

8. The portable network communication device according to claim 1, further comprising:
a coverage specifier that specifies a coverage area for a signal sent from each of the wireless base stations, with respect to each of the wireless base stations, wherein
the interface selector selects as the active network interface one of the plurality of first network interfaces having a smaller value of change than a predetermined value and being provided for a wireless network to which a wireless base station having a widest coverage belongs.

9. The portable network communication device according to claim 1, further comprising:
a locator that uses at least one of the plurality of first network interfaces to specify location information of the portable network communication device, wherein
the received signal strength determiner determines received signal strength of at least one of the plurality of first network interfaces, based on the location information specified by using another first network interface of the plurality of first network interfaces.

10. The portable network communication device according to claim 1, further comprising:
a second network interface that establishes wireless communication or wired communication with a communication terminal, wherein
the communication controller relays another packet between the active network interface and the second network interface, and
the interface selector selects one of the plurality of first network interfaces to be used as the active network interface to relay the another packet to and from the second network interface.

11. A method of selecting a active network interface that is a first network interface used to send and receive a packet among a plurality of first network interfaces in a portable network communication device having the plurality of first network interfaces that establish wireless communication with wireless base stations respectively belonging to different networks, the method comprising:
determining a received signal strength of a signal received from each of the wireless base stations via each of the plurality of first network interfaces;
calculating a value of change representing a magnitude of a change in determined received signal strength per unit time with respect to each of the plurality of first network interfaces; and
selecting the active network interface, based on the value of change that was previously calculated.

12. The method according to claim 11, wherein
the selecting selects as the active network interface one of the plurality of first network interfaces having a smallest value of change among the plurality of first network interfaces.

13. The method according to claim 11, wherein
the selecting includes selecting as the active network interface one of the plurality of first network interfaces having a smaller value of change than a predetermined value.

14. The method according to claim 11, wherein
a priority is set to each of the plurality of first network interfaces, and
the selecting includes selecting as the active network interface one of the plurality of first network interfaces having a smaller value of change than a predetermined value and a highest priority among the plurality of first network interfaces.

15. The method according to claim 11, wherein
the selecting includes selecting as the active network interface one of the plurality of first network interfaces having a smaller value of change than a predetermined value and using a lowest frequency range among the plurality of first network interfaces.

16. The method according to claim 11, further comprising:
counting a start-up time that is a time interval between a start and an end of a specific process for connection establishment in wireless communication using each of the plurality of first network interfaces, wherein
each of the plurality of first network interfaces performs the specific process with a corresponding wireless network, and
the selecting selects as the active network interface one of the plurality of first network interfaces having a smaller value of change than a predetermined value and a shortest start-up time among the plurality of first network interfaces.

17. The method according to claim 11, wherein
the portable network communication device further has a storage that stores information representing a result of a specific process for connection establishment in wireless communication using each of the plurality of first network interfaces, wherein
the selecting selects as the active network interface one of the plurality of first network interfaces having a smaller value of change than a predetermined value and a record of successful result in the storage.

18. The method according to claim 11, further comprising:
specifying a coverage area for signals sent from the wireless base stations, with respect to each of the wireless base stations, wherein
the selecting selects as the active network interface one of the plurality of first network interfaces having a smaller value of change than a predetermined value and being provided for a wireless network to which a wireless base station having a widest coverage belongs.

19. The method according to claim 11, further comprising the step of:
specifying location information of the portable network communication device by using at least one of the plurality of first network interfaces, wherein
the determining determines received signal strength of at least one of the plurality of first network interfaces, based on the location information specified by using another first network interface of the plurality of first network interfaces.

20. The method according to claim 11, wherein
the portable network communication device further has a second network interface that establishes wireless communication or wired communication with a communication terminal, and
the portable network communication device relays another packet between the active network interface and the second network interface, wherein
the selecting selects one of the plurality of first network interfaces to be used as the active network interface to relay the another packet to and from the second network interface.

21. A non-transitory computer readable storage medium having computer readable instructions stored therein, which when executed by a portable communication device having a plurality of first network interfaces that establish wireless communication with wireless base stations respectively belonging to different wireless networks, cause the portable network communication device to perform a method of selecting a active network interface that is a first network interface used to send and receive a packet among the plurality of first network interfaces, the method comprising:
determining a received signal strength of a signal received from each of the wireless base stations with respect to each of the plurality of first network interfaces;
calculating a value of change representing a magnitude of a change in determined received signal strength per unit time with respect to each of the plurality of first network interfaces; and
selecting the active network interface, based on the value of change that was previously calculated.
